(19) United States
(12) Patent Application Publication
(10) Pub. No.: US 2004/0049547 A1
(43) Pub. Date: Mar. 11, 2004

(54) Methods for providing information over networks responsive to digital device user requests

(76) Inventors: W. Donald Matthews, Toronto (CA); Dejan Slokar, Toronto (CA)

Correspondence Address: INTELLECTUAL PROPERTY GROUP, FREDRIKSON & BYRON, P.A., 4000 PILLSBURY CENTER, 200 SOUTH SIXTH STREET, MINNEAPOLIS, MN, 55402, US

(21) Appl. No.: 10/462,417

(22) Filed: Jun. 16, 2003

Related U.S. Application Data
(63) Continuation of application No. 10/327,812, filed on Dec. 21, 2002, now abandoned.
(60) Provisional application No. 60/342,626, filed on Dec. 21, 2001.

(51) Int. Cl. G06F 15/16

(52) U.S. Cl. 709/206

(57) ABSTRACT

Methods for facilitating answering requests for help or information between requesters of that help or information using digital devices and remote helpers selected to answer those requests. In one method, a computer user clicks on a help display object, resulting in a help response message being sent from a remote helper, including a network or Internet address for the helper. Accepting the help response can result in a human helper appearing in a video screen object and providing information or help through video, audio, screen sharing, and remote computer control methodologies. In some methods, a help facilitator organization uses data communication links into educational institutions, classroom located servers and digital devices coupled to those data communication links. The facilitator organization may receive help requests over the Internet from retail end user requesters or from groupings of corporate employee requesters. The help requests may be routed through the facilitator organization, with students selected to answer the help requests based at least in part on the availability of the students, and on the subject matter mastery of the students. Once selected, a more direct communication link between the requester and the student can be established.

### RELATED APPLICATIONS

The present application is a continuation of U.S. patent application Ser. No. 10/327,812, filed Dec. 21, 2002, titled METHODS FOR PROVIDING INFORMATION OVER NETWORKS RESPONSIVE TO DIGITAL DEVICE USER REQUESTS which claims priority to U.S. Provisional Patent Application Serial No. 60/342,626, filed Dec. 21, 2001, titled METHODS FOR PROVIDING INFORMATION AND FOR PROVIDING EXPERIENCE IN PROVIDING INFORMATION, both herein incorporated by reference in their entireties.

### FIELDS OF THE INVENTION

The present invention is related to systems and methods for receiving requests for information or help from a digital device and supplying the requested information over communication networks. In one example, a computer user clicks on a computer display object to request help, followed by live help being provided by a human helper visible in a video object. The human helper can provide help using video, audio, screen sharing, and remote control.

### BACKGROUND OF THE INVENTION

Productivity in commercial and personal life can be increased through use of information and technology. Much of the economic growth of the 1990s has been attributed to increased productivity which has been increasing year after year. Much of this productivity has been made possible by the increased use of information, the so-called “information economy.” Information and technology have thus acted as multipliers in increasing the effective utilization rates of human and other capital, increasing the return on investment.

While the increased use of digital devices and information technology has increased the return on investment of capital generally, a significant majority percentage of features of digital devices and digital technologies still remain unused or incompletely used. It is well known that many people are unable to program their video cassette recorders (VCRs). It is also true that most consumers of digital technologies do not utilize a significant percentage of the features of the digital technologies they already own or use, or which their employers or organization already own or use. This lack of utilization of capital could be improved by providing timely, user and context-specific training, help, or information to the person having the underutilized digital technologies. While this underutilization of capital applies to digital technologies, it also applies to capital expenditures generally, and more generally to sub-optimally utilizing human capital.

Users of computers and other digital technologies can increase their productivity and increase the return on their investments in digital technologies by receiving timely, context-specific and immediately applied training. Unfortunately, the timing, location, level, and granularity of the training is normally mismatched to the user's needs. It is axiomatic that people often learn best when solving a problem at hand or answering a question they have immediate need to answer. Digital device training may be provided six months prior to the need for the training, and long forgotten, or six months after the immediate need has gone away, and not adopted or internalized. The immediate need may require a specific answer to a specific question within a specific context often defined by highly interdependent business processes and integrated technologies. Such needs are not properly accommodated or addressed using traditional training tools. When a course is provided, the location may be off-site, or at least away from the user's desk, which generates further inefficiencies in the form of expensive opportunity costs as they are both physically and mentally removed from their job. Current training is typically carried out in groups, making the group members subject to peer pressure, which can squelch questions and reduce effectiveness.

In any case, it is unlikely that existing training solutions are provided in short, 5-20 minute increments spread sporadically about a work week, as are the needs for that training. Moreover, the principles of adult learning clearly prove learning is maximized in short, highly context-specific sessions which are immediately applied on demand within the learner's work. Due to the current mismatch between traditional training tools, learners' needs and the principles of adult education, consumers of digital technologies often flounder, fail to locate, set-up, or to use a significant majority of the features of digital technologies, resulting in being significantly less than optimally productive. This leads to a poor return on investments in digital technologies and human capital. Moreover, consumers of digital technologies also tend to ask fellow employees for help, which by interrupting them, lowers their productivity, and can result in multiple digital device users floundering and attempting to find answers.

Organizations sometimes employ help desks, often internal help desks. These help desks are staffed with a limited number of helpers, having a limited number of subject matters they have mastered. The helpers are often rated and reviewed according to the number of calls they dispose of per time period. Today's help desk business model is often based entirely on reducing call lengths, which is entirely contrary to best training practices. Today's help desk services default to solving users' problems (giving users a fish) rather than teaching them how to solve problems independently (teaching users how to fish). As a consequence, today's help desk services virtually guarantee users will call back often in search of the same answer. Although such recurring revenue is good for help desk firms, and disposing of calls quickly makes the firms look good due to the metric being measured, it results in higher help desk costs, higher levels of user frustration and lower levels of user productivity. Users dislike being given solutions they don't understand, remember, or they cannot apply immediately. In short, the users do not learn. Traditional call centers tend to experience relatively high staff turnover as their mandate to reduce call lengths can result in an unpleasant working atmosphere. In particular, helpers that provide low quality help to users but do so rapidly may look good in a metric measuring the number of calls disposed of. Conversely, a helper providing higher quality, but possibly more lengthy, training-type assistance to users may look bad according to the traditional metric used. This may lead to either poor performance reviews and/or burnout as otherwise high quality individuals are forced to give low quality answers to meet the desired management metric. Although this approach may be the correct one where providing technical support is concerned, it is most definitely not correct where learning and education are concerned.

Students in educational institutions often master a wide variety of subject matters. There is often an “application gap” between the subject matter mastered and the ability to apply that subject matter in the commercial world or any context outside of the educational institution. In one example, students may learn how to use a digital device database package, but may only use it for student-created projects or teacher-created projects, both of which may lack real world applications. One of the best ways to learn is to teach. In a typical educational institution, however, students are rarely provided with professional, real-world opportunities to teach. Students also lack any external, professional drivers forcing them to focus on the areas of commercial application of the products they are studying.

As a more general problem, many students do not have experience in practicing communications or customer presentation skills and normal business protocols and interpersonal relationship management skills. Few students graduate with any experience in setting meetings, preparing agendas, chairing meetings, and drafting meeting minutes or real life sales and marketing skills. There are countless, basic yet important, examples of this application gap between school and the work force. This lack of “real world” context put students at a distinct disadvantage during job interviews, after starting jobs, in dealing with clients and co-workers in a business setting. Moreover, students' lack of “real world” context also requires employers to spend more capital resources in training students in subject matters our secondary and post- secondary educational institutions largely fail to provide today. Examples of business skills include, but are not limited to, presentation skills, needs assessment, managing expectations, initiating, maintaining, shepparding and concluding helpful discussions with clients who may be distraught, angry, and/or confused.

In another problem area, clients may come from a totally dissimilar socioeconomic background than the students. For example, it may be difficult for a bright, technically oriented person to initially relate to and converse with a senior executive who does not know what a cursor is. The only thing that is preventing the student from helping the executive is a little training in business practices and perspectives. Often, technical people are very comfortable talking to each other, but not with ordinary consumers who tend to be seriously lacking in technical know-how. Students benefit in many ways by obtaining commercial experience and interfacing with clients, while still under supervision within the educational institution.

Educational institutions and governments often face significant problems and costs in successfully transitioning students from school into the workforce. In many cases, public educational institutions are unaware of or fail to provide students with the exact skills required or desired by local employers. Other times, the students supplied by educational institutions have sufficient technical training, but have not learned how to apply their skills in a professional setting or in the context of those problems encountered by employers. The governmental and/or educational institutions in fact often lack sufficient monies to purchase digital device systems and networks sufficiently modern to mirror the types of equipment to be found by their students after they leave the educational institution and enter an outside organization.

What would be desirable are methods for providing commercially relevant skills and work experiences to students in the area of providing information and/or assistance to consumers of digital technologies, and assisting those students in transitioning from school to work, all independently of government funded unemployment programs or public education funded school curricula. What would also be desirable is a method for providing near instantaneous, appropriate length one-on-one tutoring and help to consumers of digital technologies in need of support. What would be advantageous are methods that provide modern equipment and commercially relevant training to educational institutions.

### SUMMARY OF THE INVENTION

The present invention includes hardware and software solutions to two problem areas. One problem area includes students not bridging the gap between academics and failing in more directed business-like settings, to develop general business skills. Another problem area includes consumers of digital technologies not being able to utilize significant portions of their technologies because they can not obtain timely help and training tailored to their particular needs. The present invention includes methods for instantaneously receiving help requests from end-users, and intelligently routing the help requests through various software components and algorithms which select appropriately skilled and available student helpers. The student helpers are preferably in a supervised classroom setting to receive and satisfy the requests in subject matter areas they are trained or experts in. After being selected to receive the help request, the student helper and the help requester can establish a direct communication link between themselves followed by a one-on-one help or tutoring session using one or more of synchronous voice, synchronous video, application sharing, and screen sharing Internet technologies. Being private, there is no peer pressure which often reduces the effectiveness of training. The invention also enables selectively and intelligently adding value through cross-selling.

In a chronological description of one example of the invention, the facilitator organization can sign an agreement with a public or private educational institution to provide the facilitator organization with access to the classrooms, curriculum managers, marketing managers, and student body. The facilitator organization can agree to provide the educational institution with trainers (teachers), and an approved class curriculum designed to improve, among other things, the students' communication, technical, and general business skills. The educational institution may agree to offer one or more of the classes developed and taught by the facilitator organization to its students. In particular, the educational institution can also permit students enrolled in those classes to answer requests for help or training from the facilitator organization's client base located remotely to the students. All students are preferably certified by the facilitator organization in order to qualify for servicing the facilitator organization's clients and to receive wages. Students may receive approved academic credits for the training and professional work experiences they receive from the facilitator organization through their class work.

After agreeing to provide such classes, the facilitator organization can provide a communication link to the educational institution, and further provide links to classrooms or other supervised settings within the educational institution for use during the classes. In one example of the invention, the facilitator organization provides the educational institution with all systems required to link the facilitator organization's clients to the educational institution's classrooms and students via a high speed Internet communication link. The systems provided to the educational institution by the facilitator organization include, among other things, high speed Internet connectivity, sophisticated digital device servers, routers, hubs, local area networks, digital devices, for example computers, for all students in such classes and required software (“partnership IT systems”).

The students may be taught how to manage client calls and conversations, elicit and define the requester's problems, help the requester learn how to resolve the problem independently by offering training solutions to the problem, followed by winding up the help session and then sending follow-up notes from the session. The students may also be trained to identify what professional roles and responsibilities the requester plays within their organization, and based on that, to deduce what other interrelated technologies and technological features are most likely to increase the requesters' productivity. For example, an administrative assistant may call requesting help setting up an automated mailing function within a word processing application. The student helping that requester may be trained to enquire and assess exactly how that requester is populating their mailing database to determine if it is being input manually, or being copied over from another company database and, if so, how. The student may determine if the copying is being done by “cutting and pasting” or by exporting the data from a spreadsheet or from a database. In most cases, the student will be able to train the requester to dramatically reduce the time taken to achieve their objectives.

This type of training results in high value added consulting services which end up saving the requester and his/her organization significant time and capital. In a preferred embodiment, the student helpers are only allowed to be selected to receive calls from requesters after they have been certified by the instructor-supervisor as sufficiently proficient to handle the help requests. The level of supervision applied to a student or the level of autonomy a student may have in servicing requesters may depend on the level of certification a student receives from the instructor-supervisor in relation to the level of service sophistication and complexity required by the facilitator organization's clients.

The students can attend regularly scheduled classes in a supervised classroom setting, where the communication between the student helpers and the help requesters can be monitored by the supervising instructor. The student helpers can log into digital device workstations in some embodiments, signifying their availability on-line to handle questions. As part of the facilitator organization's certification process, students will complete skill-testing subject matter questionnaires to define their skill ratings in the subject matters in which they are proficient. This subject matter determination is preferably done prior to accepting the students into the class, and, as much as possible, will preferably be done automatically using the facilitator organization's Skills Inventory Systems. Once certified by the facilitator organization, and after logging into the computer or other digital device workstations, the student helpers are ready to provide assistance to remote help requesters.

A help requester may have a computer or other digital device related question, for example, a question related to how a digital device related task is to be accomplished using a software package. The requester can select on a help object on the requester's display screen, thereby sending a message or establishing a link to the facilitator organization and sending some help request attributes indicating the nature of the help requester, the subject matter in question, and a help request identifier. If the help requester is authorized to receive help, the facilitator organization's HELPTRAIN Systems automatically select a student helper to obtain a good match to, among other things, the requester's subject matter, employer, level of expertise, geographic location, language, time zone, employer-authorized privileges, past service satisfaction levels with the facilitator organization, account balance or other financial information, and combinations thereof. After the appropriate student helper is selected, the requester's request can be sent to the selected student helper. The help desk software or student helper can respond to the requester by sending back a unique identifier or address that allows the student helper to be reached more directly. After receiving the student helper identifier, the requester can use this identifier to establish a more direct communication link to the student helper. In one example, the Internet protocol address of the student helper is sent to the software program running on the requester's digital device, which uses the student helper's Internet protocol address to automatically establish a more direct link over the Internet. In one embodiment, software sends a request for communication automatically by sending back a unique identifier or address that allows the student helper to be reached using real time communication (audio, video and otherwise): The requester's PC can use this information to automatically establish a more direct communication link to the student helper.

With a help session established, the requester can request help through any suitable media, including text, voice, video, screen and/or application sharing and URL push. In one method, a small “window” bearing a periodically refreshed/updated video image of the student helper appears on the requester's screen, and a synchronous audio transmission of the student helper and requester's voices is transmitted back and forth between their respective digital devices. The student helper can thus have a real-time, audio and visual presence on the screen of the person being helped. In one embodiment, the requester can also allow the remote student helper to view, in real time, the same display screen seen by the requester. In a preferred embodiment, the student helper may request remote control of the keyboard entries, and cursor movements. The help requester can then allow the student helper to remotely control one or more applications currently active within the requester's digital device with the requester at all times able to instantaneously take back control of the system.

Over the course of a help session, the student helper can provide instantaneous and responsive audio, visual, screen sharing, application sharing and data input to the help requester to both solve the immediate problem and provide carefully tailored training to the help requester. At the conclusion of the help session, the student helper can summarize the contents of the help session in a training reference database for later retrieval by the requester from any Internet connection, and then end the help session or retrieval by other third parties for marketing research, new development, cross selling, up selling and other purposes. The help session is preferably monitorable by the supervising instructor in the supervised classroom setting. The help requester can be billed for the amount of help received.

One preferred use of the present invention is to provide rapid response to digital device users requests for digital device-related subject matter problems, questions, or training needs over the Internet. In this preferred use of the invention, a networked digital device user can click on a help icon on their local digital device display screen and receive direct and individually tailored information and solutions to their problems interfacing through their digital device screen, provided by a student helper located in a supervised classroom setting in an educational institution, where the student helper is also using a digital device linked to the Internet.

In a broad use of the present invention, the help requester at the digital device display may be requesting help with a subject matter unrelated to digital devices, where the subject matter may be any subject matter. In another use of the present invention, a requester who is an employee of a user organization, such as an employer, may send the help requests through the user organization's digital systems and networks, where the user organization may be the payor for the help provided. In some situations, the user organization is an ad-hoc user organization such as an electronic retailer or an Internet portal or a Value Added Reseller which may provide and/or resell the service to its end-users and/or clients.

In a still broader use of the present invention, the help requester may be located anywhere, using any communication link, and have a question to be answered, have a training need, or have a problem requiring a solution. This embodiment of the present invention is only limited by the helpers' ability to provide value-added help to the requesters. In a preferred embodiment, the helper is a student helper in the supervised classroom setting in an educational institution.

One use of the present invention is to obtain answers to technical set-up, personalization, and usage questions related to digital devices, where students may have recent training and/or be early adopters. The present invention may however be used for many subject matter areas. The present invention may be used to provide students in a wide variety of work of extra mural activities such as auto mechanics, nursing, social work, and law with supervised experience in providing assistance and advice under the supervision of an instructor in a classroom setting. This improved training may serve to bridge the gap between academic classroom exercises and real world problems which the students will ultimately face, and which the methods of the invention will better prepare them for. In addition to being better prepared to make positive contributions to the economy, the students and/or educational institution can receive payment for the training and work experiences.

### DESCRIPTION OF THE DRAWINGS

FIG. 1 is a schematic diagram illustrating one method according to the present invention including retail end users, user organizations, facilitator organizations, educational institutions, classrooms, and student helpers;

FIG. 2 is a subset of FIG. 1, having only one user and one student helper;

FIG. 3 is a timeline of information exchanged between a help requester and a student helper;

FIGS. 4-18 are screen captures taken of an end-user's screen while using an Internet web browser to interface with the invention as described herein;

FIGS. 19-22 are screen captures showing what a student helper in a supervised classroom setting will see while interfacing with one example of the invention;

FIG. 23 is a diagram of one method according to the present invention;

FIG. 24 is a flowchart of a retail user purchase process flow for purchasing help in one method;

FIG. 25 is a flowchart of a corporate user or user organization purchase process flow for purchasing quantities of help in one method; and

FIG. 26 is an architecture diagram of one system suitable for implementing methods according to the present invention.

### DETAILED DESCRIPTION OF THE PREFERRED EMBODIMENTS

The following detailed description should be read with reference to the drawings, in which like elements in different drawings are numbered identically. The drawings, which are not necessarily to scale, depict selected embodiments and are not intended to limit the scope of the present invention. Several forms of invention have been shown and described, and other forms will now be apparent to those skilled in art. It will be understood that embodiments shown in drawings and described below are merely for illustrative purposes, and are not intended to limit the scope of the invention as defined in the claims which follow.

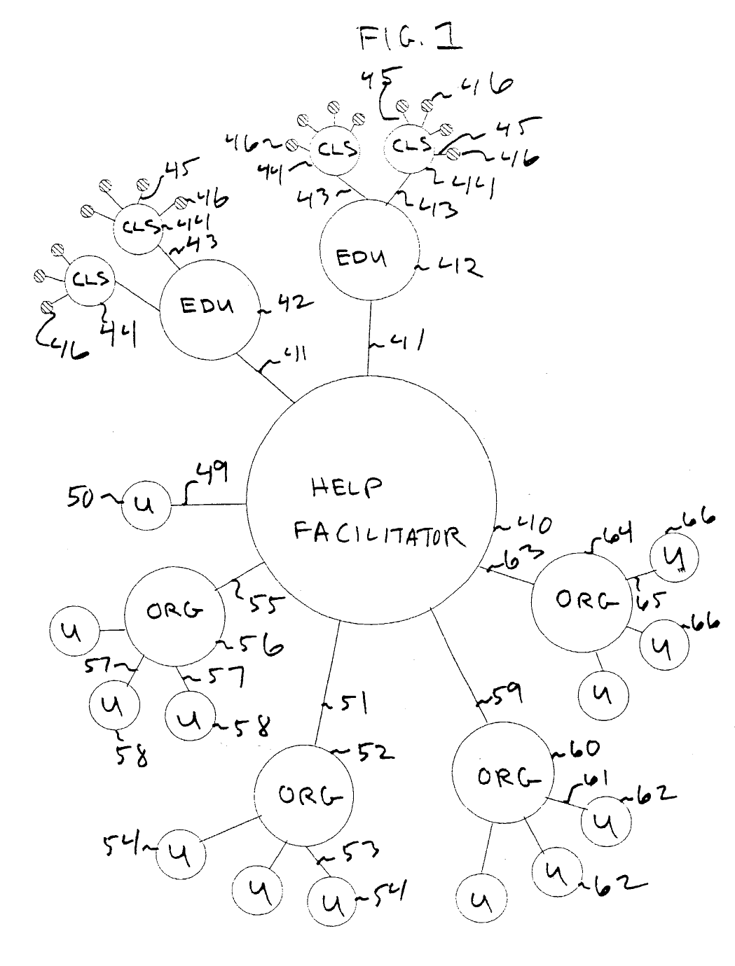

FIG. 1 illustrates a high level organizational diagram showing the interrelationships between the major entities which can be involved in the present invention. The entities are represented by nodes, and the communication links between the entities are represented by lines connecting the nodes. At the center of the diagram is the organizational entity which may be referred to as the help or information facilitator 40. Help facilitator 40 acts as an intermediary or catalyst to facilitate information exchange between the other entities. Help facilitator 40 can be coupled or linked to educational institutions 42 by communications link 41. Educational institutions 42 are linked to supervised settings which can be classroom settings 44 through communication link 45. Classrooms 44 are illustrated as linked to students 46 through communication link 45.

Classrooms 44 can be linked to educational institution 42 through communication link 43. While students 46 may be viewed as mapped to individual communication nodes such as networked personal computers or personal digital devices in one view of the invention, in a preferred view of the invention, students 46 are aggregated within classrooms 44 and are identified by unique student identifiers not permanently linked to any particular physical communication node. As used herein, the phrase “digital device” refers broadly to any device which can be used to electronically communicate between two remotely situated people, each person having such a device. Digital devices include, but are not limited to, personal computers, general purpose computers, personal digital assistants, handheld or palm computers, wired or wireless keyboards with displays, set-top boxes, game machines, control systems and cellular or wired telephones. In a broad description of the invention, communication link 41 can be any communication link between help facilitator 40 and educational institution 42. Communication link 41 could thus be a wired or wireless telephone link, a wired or wireless text based communication link, or a wired or wireless digital device network link. In a preferred embodiment of the invention, communications link 41 is a network communications link representing a portion of the Internet. In a most preferred embodiment, communication link 41 is a high speed data communications link, for example, what is currently referred to as a “T1” communication line. In this embodiment, communication link 41 is therefore part of the Internet and is not necessarily a direct, one-to-one link exclusively between help facilitator 40 and educational institution 42.

The classrooms or other supervised settings 44 can be linked to educational institution 42 by communication link 43. In one embodiment of the invention, educational institution 42 has at least one server connected to high speed communication link 41, with classrooms 44 having hubs coupled to the servers through data communications links 43. Within classrooms 44, individual students 46 may be logged into individual communication devices on human interface devices, for example, digital devices which can be linked to a hub in each classroom through communication links 45. As may be seen from inspection of FIG. 1, there can be numerous educational institutions 42, each having numerous classrooms or other supervised settings 44, each having numerous students 46 aggregated within.

Help facilitator 40 may be seen linked to an individual user, end user, or help requester 50, as these terms are used in the present application. User or requester 50 is coupled through data communications link 49 to help facilitator 40. Help requester 50 may also be referred to as a direct end user or retail end user as they are coupled directly to help facilitator 40. In one example of the invention, retail end user 50 can have a prepaid, individual account, paid for by a personal credit card or electronic cash equivalent. This prepayment can authorize retail end user 50 to request help directly through help facilitator 40. The help request can then be routed to the appropriate educational institution, classroom, and student, as will be explained below.

Various user organizations 56, 52, 60, and 64 are also illustrated in FIG. 1 and will be explained further. The user organizations can act as intermediaries between end users who often are not allowed direct access to help facilitator 40. In some embodiments, user organizations are the organizations which are directly responsible for paying for the help received and may be billed directly for the help received by help facilitator 40. User organizations may also be referred to as user aggregates, as the users may not consider themselves to be a member of any “organization.” An Internet portal may be referred to as a user aggregate.

User organization 56 is a information service provider (ISP) which can offer Internet access to its end users 58 through communication links 57. One example of an information service provider could be America Online (AOL) and another example could be ATT Worldnet. In these embodiments, communication links 57 may represent dialup, modem communication links between end users 58 and the user organization or ISP 56. In this embodiment, end users 58 may be requesting help or information with aspects of the ISP itself and/or goods or services featured or advertised on the ISP. Help or information requests received from end users 58 through communications links 57 may be forwarded through communication link 55 between the ISP user organization and the help facilitator 40.

Another example of a user organization may be found in employer organization 52, having employee end users 54 coupled through communication links 53. In this example of a user organization, employee end user 54 may be coupled through any suitable communication link, for example, a corporate LAN to a corporate server, which is coupled through communication link 51 to help facilitator 40. In one example of the invention, communication link 51 can be a high speed connection to the help facilitator through the Internet. In the employer user organization, employees 54 may be requesting help with software products used by the employees, where the employer wishes to have the help or information requests sent outside of the organization. In this example of the invention, the employer organization may be responsible for paying for the information or help provided to employee end users 54.

In yet another example of a user organization, product provider user organization 60 may have customers or potential customers 62 linked through communication link 61. One example of a product provider user organization could be a web site maintained by a motor vehicle company, for example, Ford Motor Company. Customers or potential customers 62 could make inquiries about products such as automobiles they wish to purchase, or have already purchased. Suitable requests for information could be forwarded from customer end users 62, through communication link 59 to help facilitator 40. In this example of the invention, the product provider, such as Ford, may be responsible for paying for the information provided to customer end users 62.

In yet another example of the invention, a user organization may be an ad hoc user organization such as an on-line catalog or electronic retailer 64. On line catalog 64 may have otherwise unrelated items featured, being browsed by potential customers 66 through communication links 65. Inquiries from potential customer 66 may be forwarded through on-line catalog 64 to help facilitator 40. In this example of the invention, catalog 64 may be willing to pay for suitable information provided to potential customers 66 in order to facilitate sales.

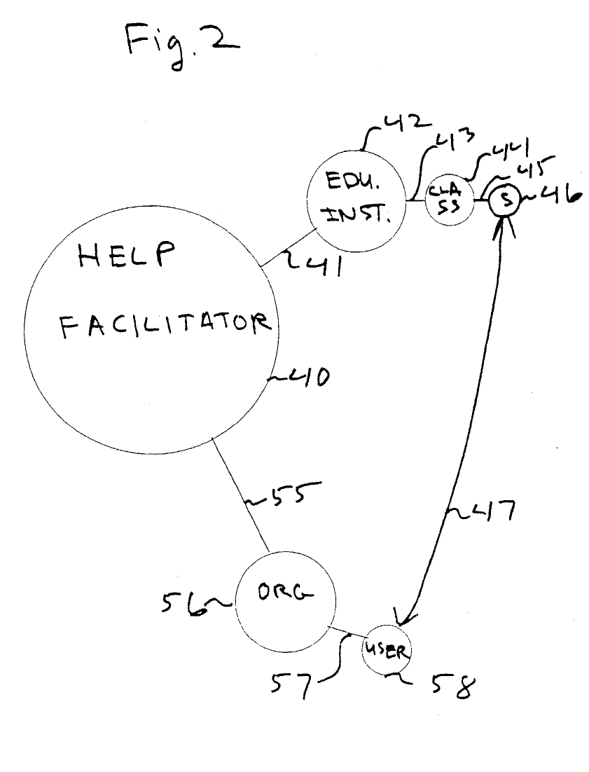

FIG. 2 illustrates a subset of the diagram of FIG. 1, to simplify the explanation of the invention. End user or requester 58 is coupled through a communication line 57 to a user organization or aggregate 56 which in turn is coupled through communication link 55 to help facilitator 40. Help facilitator 40 is coupled through communication link 41 to educational institution 42 which is in turn coupled to classroom 44 through communication link 43. A student 46 is coupled through communication link 45 to classroom 44 through communication link 45. In the embodiment illustrated, student 46 may be understood to have an address or unique identifier which allows accessing student 46 through the communication link. Similarly, in some embodiments of the invention, end user or help requester 58 also has a unique address or identifier which enables communicating with the end user through the communication links. In a high level view of the invention, the addresses or unique identifiers could be any suitable identifier or number, for example a phone number, which allowed a connection between end user 58 and student 46. In a preferred embodiment of the invention, the addresses or identifiers are digital device network addresses or identifiers. In a most preferred embodiment of the invention, the addresses are Internet protocol (IP) addresses.

Beginning with end user 58, a help request may be generated, for example, from a digital device display help object on digital device displayed help facilitator link object. In one example of the invention, end user 58 manipulates an object to indicate that help is requested for a common software program. The help request is sent through communication link 57 to user organization 56. User organization 56 may filter or further process the help request. Payment or prepayment may be checked for in the case of an ISP user organization. In the case of an employer organization, other criteria may be used. The help or information request 55 may then be passed on through communication link 55 to help facilitator 40.

The help or information request can have different attributes in different embodiments of the invention. In one embodiment of the invention, an end user identifier, and the subject matter of the request are included as attributes of the help request and are sent to help facilitator 40. An example of an end user identifier may be a formal or informal name. One example of a subject matter is Microsoft Word. Other embodiments of the invention may also include the user's geographical location, time zone, language, previous help history, and explicitly offered or inferred level of subject matter mastery.

As will be discussed in more detail below, the help request is then intelligently routed to the appropriate student in order to obtain the requested help or information. The selection process can include the instantaneous or immediately expected on-line availability of the student, the language of the student, the time zone of the student, the subject matter expertise of the student, and/or the subject matter mastery level of the student. Based on any or all of these criteria, the help request can be sent to an individual student 46 through communication link 41 to educational institution 42, then through communication link 43 to a classroom or supervised setting 44, then to student 46 through communication link 45. As is explained elsewhere, classroom 44 preferably has a supervisor or teacher present who has the ability to monitor the communication between student 46 and end user 58.

Once the help request is received by student 46, a more direct communication link may be established. In the example of a digital device network being used as the communication link, for example, the Internet, a more direct connection between student 46 and end user 58 may be established. In one example of the invention, the IP address of student 46 is sent to end user 58, with an invitation for end user 58 to open the direct communication link. In another example of the invention, end user 58 has implicitly given permission for the direct communication link to be established by requesting the help or information. In this example of the invention, software on the digital device of student 46 may be used to send back the Internet protocol address of student 46 to end user 58, where software operating on a digital device of end user 58 then uses the IP address of student 46 to establish a more direct connection over the Internet. In one embodiment of the invention, when no suitable helper is available, the end user or help requester may receive notification of this. The user may later receive notification, for example, through e-mail, that a helper is available and be invited to establish a connection.

In one example of this procedure, end user 58 effectively attempts to open a Internet conference or net meeting with student 46. Student 46 then responds to this request by providing the IP address of student 46 to end user 58. When the end user pending Internet meeting or net meeting software receives the IP address of student 46, a more direct connection between end user 58 and student 46 may be established. The more direct connection may in fact be a very indirect connection through the Internet, but which does not necessarily go through help facilitator 40. The more direct connection is illustrated at 47.

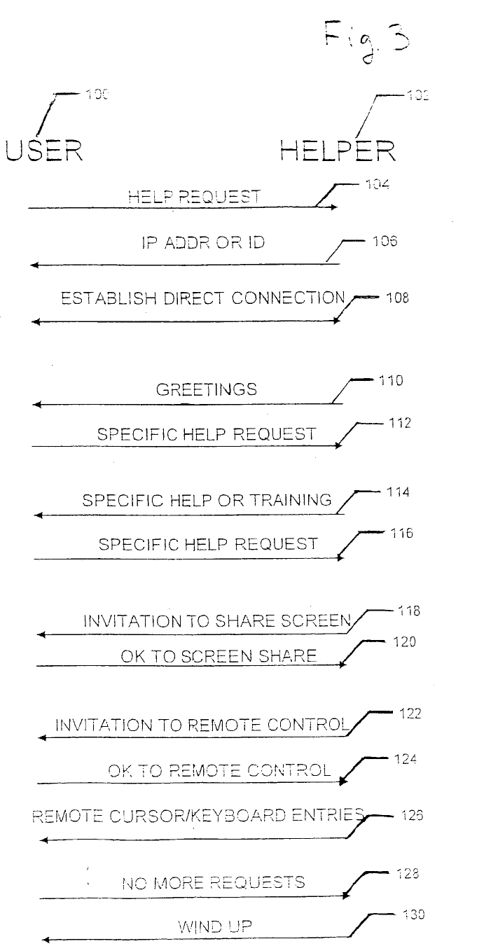

FIG. 3 illustrates a timeline or communication diagram between a user 100 and a student or helper 102. In this example, the progression of time is indicated from top to bottom. An initial help or information request 104 is sent from end user or requester 100 to the student or helper 102. The help request is represented at 104. In response, student 102 sends IP address 106 to user 100. The end user may then use the received IP address to establish a more direct connection at 108. An initial greeting or salutation 110 may then be sent from student 102 to user 100. This can include any combination of video, audio, and text. A specific request for information may then be sent by the user at 112 to the student. More specific help or training may then be sent back by the student as indicated at 114. The steps 112 and 114 may be repeated several times as help requests and offered help are exchanged. Another help request at 116 is made by the user, but with the student offering at 118 an invitation for the user to share the user's digital device display. In one embodiment, this invitation is an oral invitation by the student suggesting that the user OK screen sharing with the student. This can mean that the student wishes to see the same display that the user is seeing on their local digital device. In this example, the user grants this permission, for example, by manipulating an object on the screen, thereby sending message 120 granting permission for the screen display sharing. In one embodiment, the user clicks on a “Share My Screen” button on the user's screen. This action can initiate the screen sharing with the student. The screen or digital device display image may also be sent as a copy at 120 to the student.

Similarly, at 122, the student has issued an invitation to the user to allow the student to remotely control data entry to the user's local digital device. Specifically, the student may be requesting permission to manipulate the cursor on the user's display and to make keyboard entries into display fields. Permission may be granted by the user at 124, again by manipulating an object on the screen. At 126, student 102 may move the cursor, click on objects, and enter keyboard keystrokes to fill in data fields from the student's remote location onto the user's digital device display. The above process can continue with help and training being offered in response to help requests made.

Referring again to greetings 110, the greetings, and other communications from student to user, may be made by any combination of suitable video, audio, and/or text communication. In a preferred embodiment of the invention, the student is able to communicate through video, audio, and text to the end user. While the end user may have video and/or audio to respond, in one embodiment of the invention, the user may make help requests through text.

When the end user has been satisfied or otherwise wishes to end the session, this may be indicated by communication 128 in a wind-up session, responded to by the student at 130. In one embodiment, the user can end the remote control at any time simply by pressing a key or cursor button. In some embodiments, the user is orally invited by the student to press a key as part of the wind up session. The communication link established previously may then be terminated. After termination of the session, the student may summarize the session in text, for example, summarizing the information provided, and entering additional billing information if required.

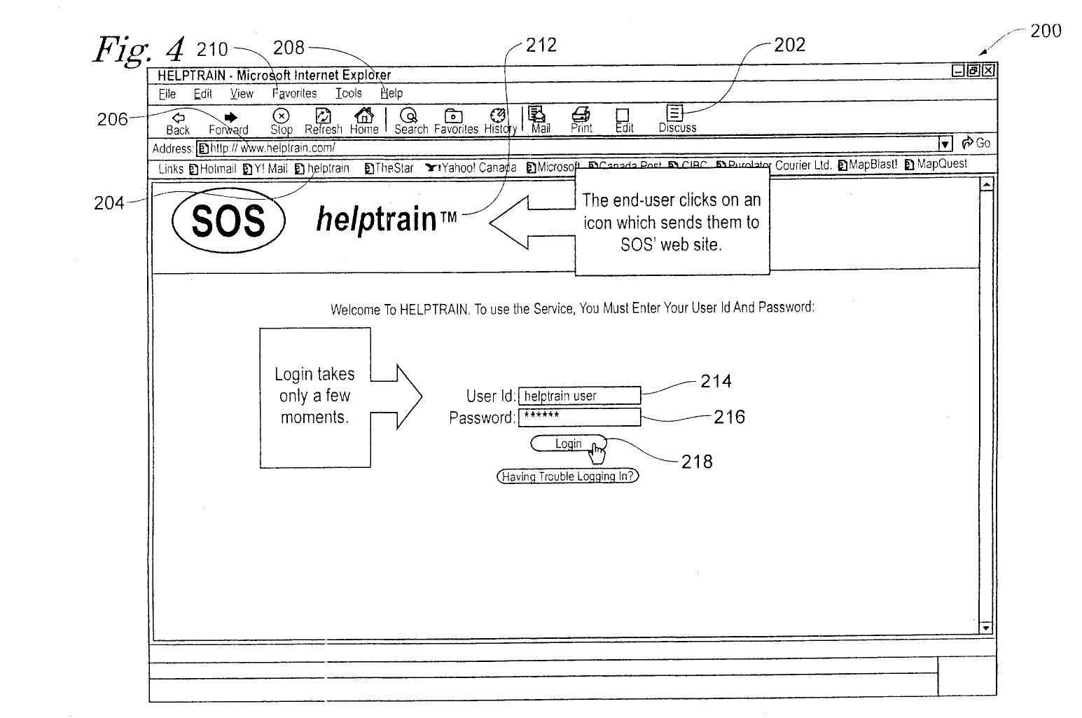

FIGS. 4 through 18 illustrate digital device displays that are illustrative of the type of displays that may be seen by a help requester using one embodiment of the present invention. While some embodiments of the present invention utilize other communication links and other human interface devices, the digital device display aspect of the present invention is a preferred aspect and may be used to illustrate a preferred embodiment of the present invention.

FIG. 4 illustrates a digital device display 200 which, for example, may be displayed with a cathode ray tube or LCD display panel. The display contents 202 illustrate various ways in which help may initially be requested by the help requester or end user. A link or other desktop object 204 may include a link or identifier of a facilitator organization or product, which in the illustrated example, is “HELPTRAIN”. As used herein, the phrases “facilitator organization” and “help facilitator organization” may be used interchangeably, with both referring to organizations which facilitate information exchange generally, not limited to facilitating responses to help requests. The facilitator organization may also be reached by typing in a digital device network address, for example, a URL, as shown at www.HELPTRAIN.com at 206. In another embodiment, a generic help object 208 may include a dropdown list which may then include a link or object to enable reaching the help facilitator organization. The link to the facilitator organization may of course be stored in a favorites list 210 as illustrated in FIG. 4. In another example, not requiring separate illustration, a help facilitator indicia, for example, a logo, may accompany software products or even retail products as displayed along side file lists on the digital device display. In this example, the help facilitator may be reached by selecting on the indicia accompanying the product in the list displayed.

In the example of FIG. 4, the facilitator organization (here being SOS, featuring the product HELPTRAIN 212) has resulted in a display being provided which invites login by the user. A prompt and entry field 214 requests the user id, while the password prompt and entry field 216 requests the user password. A login object 218 invites submitting the login information. As previously discussed, the user may be either a direct, retail user having payment terms perhaps previously agreed to, or may be a less direct user coming through a user organization or aggregate.

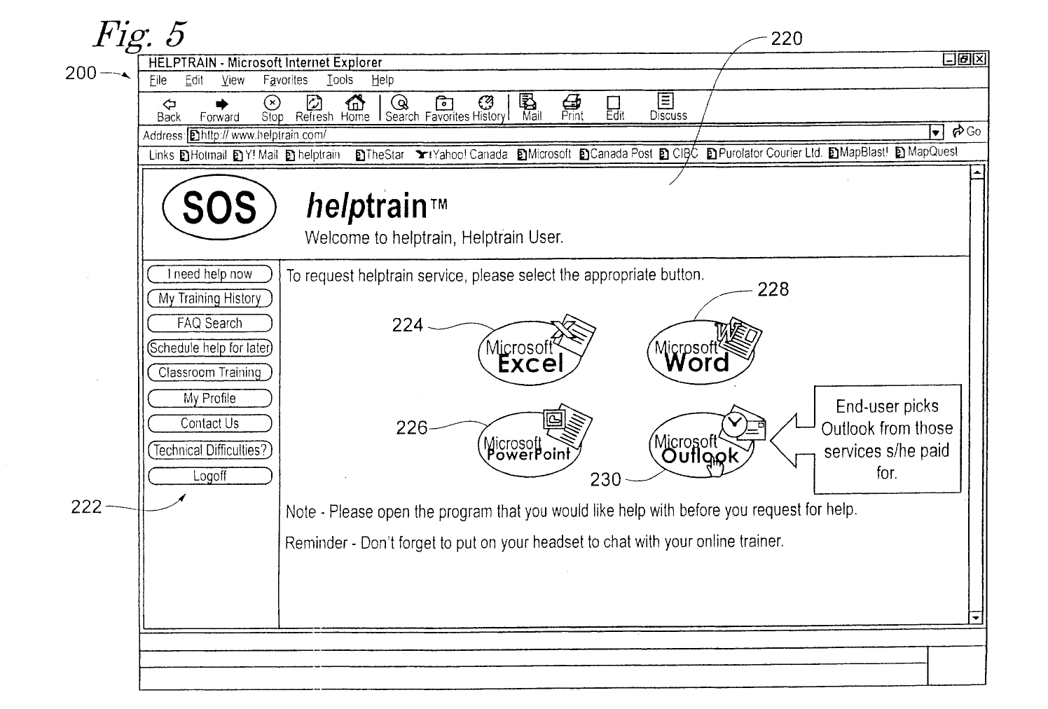

FIG. 5 illustrates display 200 bearing another display screen 220 featuring a list of help facilitator features 222 and a list of supported products including a spreadsheet product 224, a presentation product 226, a word processing product 228, and a database product 230. In other embodiments, the products supported may include other subject matter areas, with the software products subject matters being used only for illustration. Other, non-limiting examples of subject matters include new automobile products, health questions, legal questions, automobile repair subject matter areas, and other consumer subject matter areas. Subject matter choice methods may be various including menus.

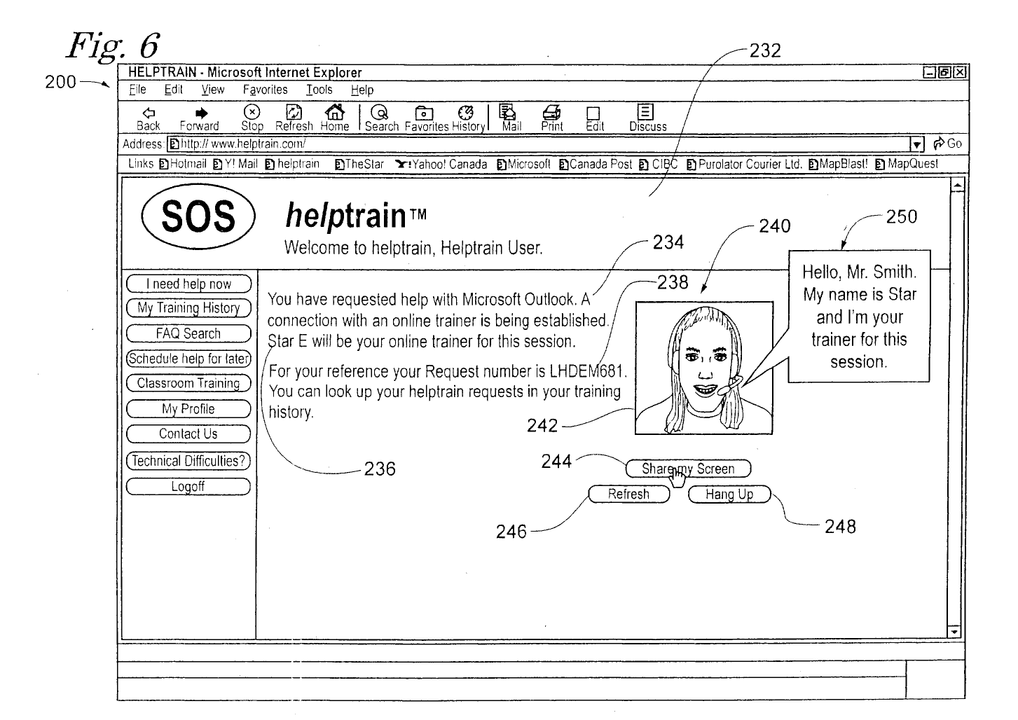

FIG. 6 illustrates another screen 232 resulting from the requester selecting on database subject matter object 230 in FIG. 5. The help request may thus be accompanied by attributes such as the subject matter identity as well as the identity and name of the requester. The identity of the requester may be used to group the requester into manageable aggregates, which may be pre-assigned to educational institutions and classrooms in certain time zones which support the user's native language. The attributes accompanying the help request may be used to select a currently available student having the necessary subject matter expertise and language proficiency required to talk to the requester.

After the helper has been selected and linked to, over the communication link, a helper communication object 240 may be displayed on the requester's digital device display. Helper object 240 may include a video object 242 which is updated, and an audio object 250 which projects the voice of the helper in substantially real time to the requester, for example, over the requester's headphones or speakers. FIG. 6 illustrates the audio/voice response of the helper in a box 250 for purposes of illustration. Helper object.240 may also include a screen share object 244 which, when selected, allows the remote helper to view substantially the same screen as the requester. Helper object 240 can also include a refresh button 246 to refresh the session, and a hangup object or connect object 248 to disconnect the session. In addition to the initial greeting or salutation delivered through audio at 250, a text salutation and greeting 234 may also be included, given the helper's name or identifier 236 and also a session identifier or reference number 238.

In one embodiment of the invention, helper object 240 is created by adapting video conferencing or video meeting software. In one illustrative example, the Microsoft Net Meeting software has been adapted to serve as the helper object 240. The video conferencing object may be adapted for appropriate use by disabling or not enabling unneeded features. In particular, white board features and even video transfer from the user to the helper may be disabled in some embodiments.

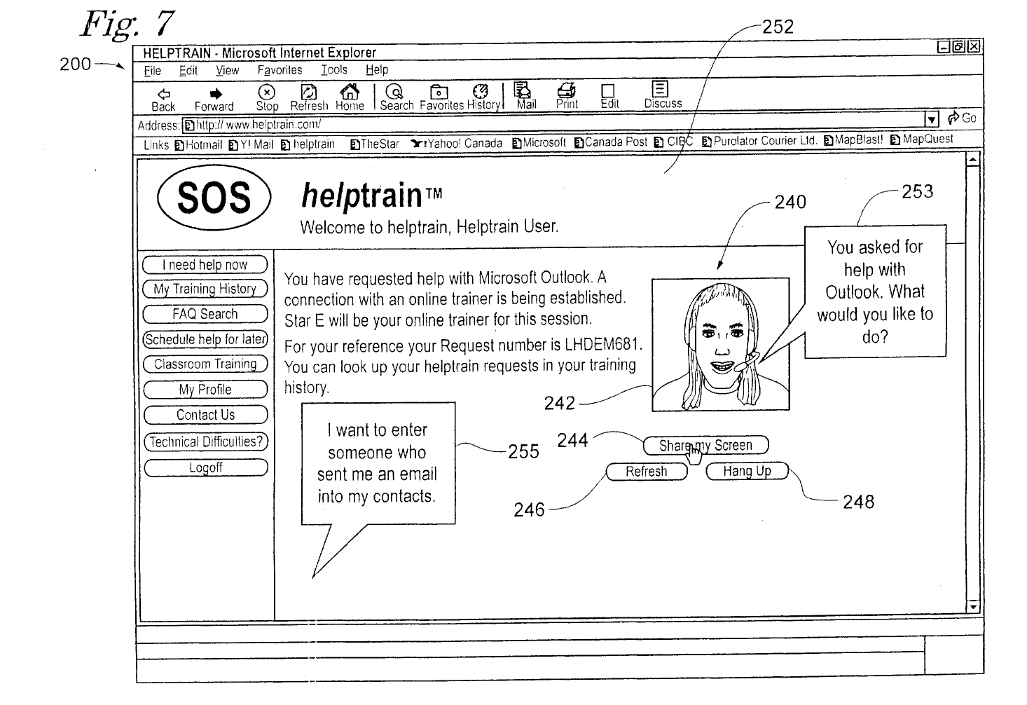

FIG. 7 illustrates another display screen 252 in which the requester makes a specific help request through a voice entry device such as a microphone at 255. The help requester audio input is represented by a box 255 in FIG. 7 for the purposes of illustration. Helper object 240 receives this oral help request over the communication link established and responds orally at 253, with periodically updated video being included at 242 in some embodiments.

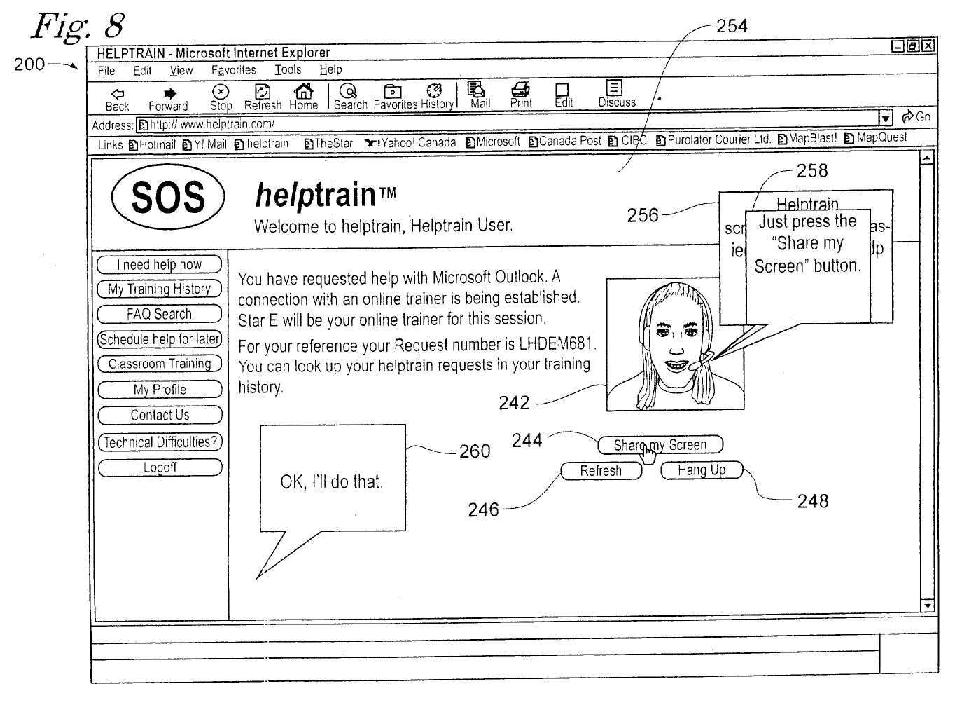

FIG. 8 illustrates the situation, which can be several question and answer sessions later than FIG. 7, where helper object 240 invites the requester to share the requester's screen at 256. The requester orally accepts this invitation at 260 and selects the screen share object at 244 to enable the helper to view substantially the same screen as the requester.

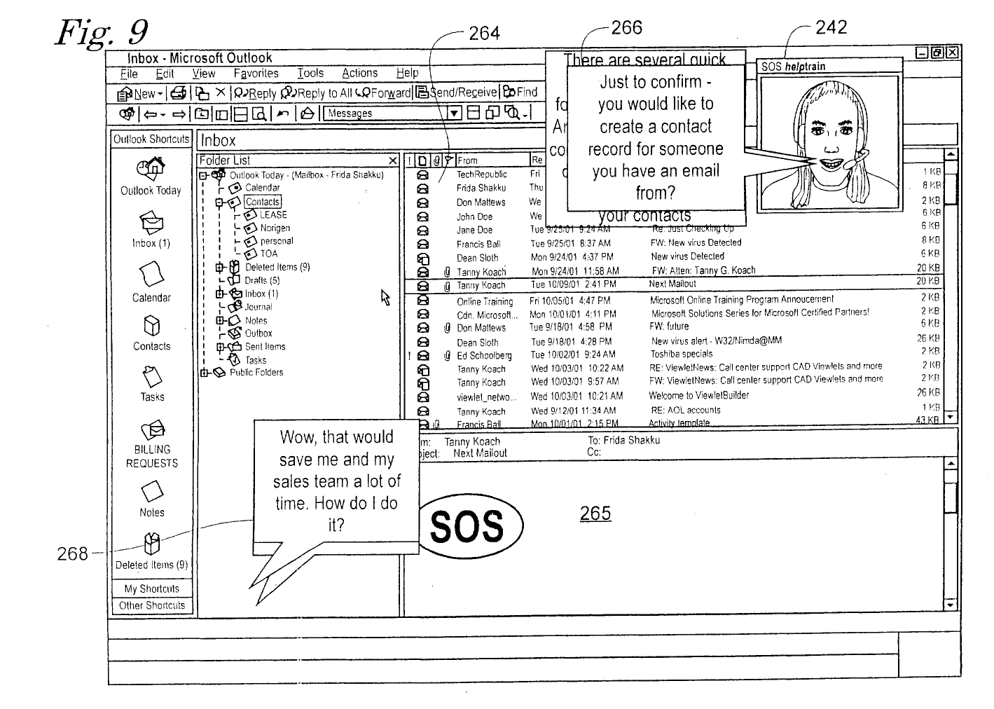

FIG. 9 illustrates the digital device display several questions and answers later, including multiple, overlayed offers of help and information from the helper at 266 and multiple responses from the requester at 268. As may be seen from FIG. 9, the video component 242 of helper object 240 preferably floats on top of the application being worked on, making the helper object visible and preferably out of the way at all times. In FIG. 9, requester has pulled up an email list 264 and has selected a particular email 265. This is visible to the remote helper as the screen share has been enabled.

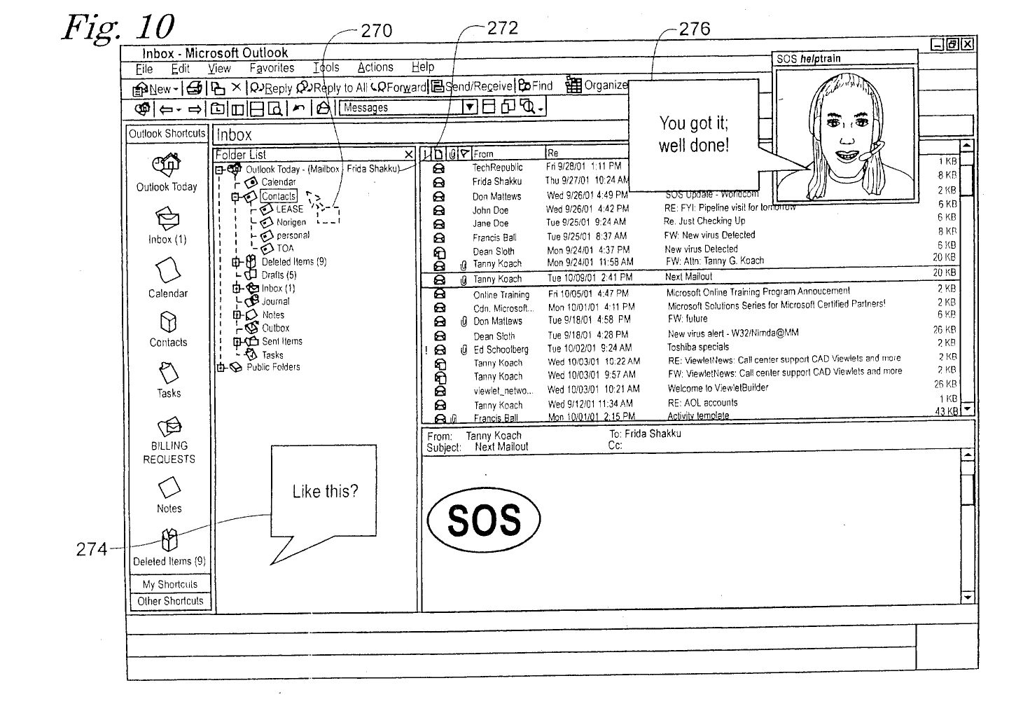

FIG. 10 illustrates a subsequent display where the requester communicates to the helper at 274 and performs a digital device action by dragging an email sender name to a contact list 272 as indicated at 270. Again, this is visible to the remote helper as the screen share option has been enabled. The helper sees this and comments favorably as indicated at 276.

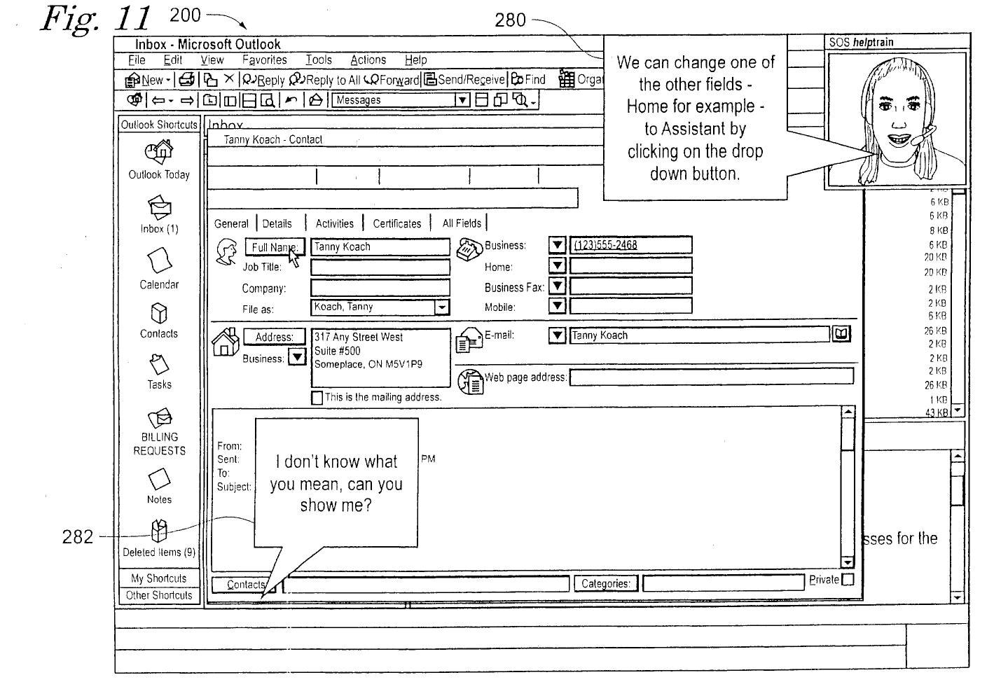

In FIG. 11, when demonstration becomes relevant in a training session, the remote helper can take the initiative and offer to provide help, information, or other training as indicated at 280. The requester can respond as indicated at 282. In other embodiments of the invention, the ensuing dialogue can be used to direct the requester to appropriate sites, including commercial sites having the possibility of sales resulting from the referral. While this may be inappropriate in some situations, in other situations, for example, browsing car models, this may be the driving force and reason behind the help or information being provided.

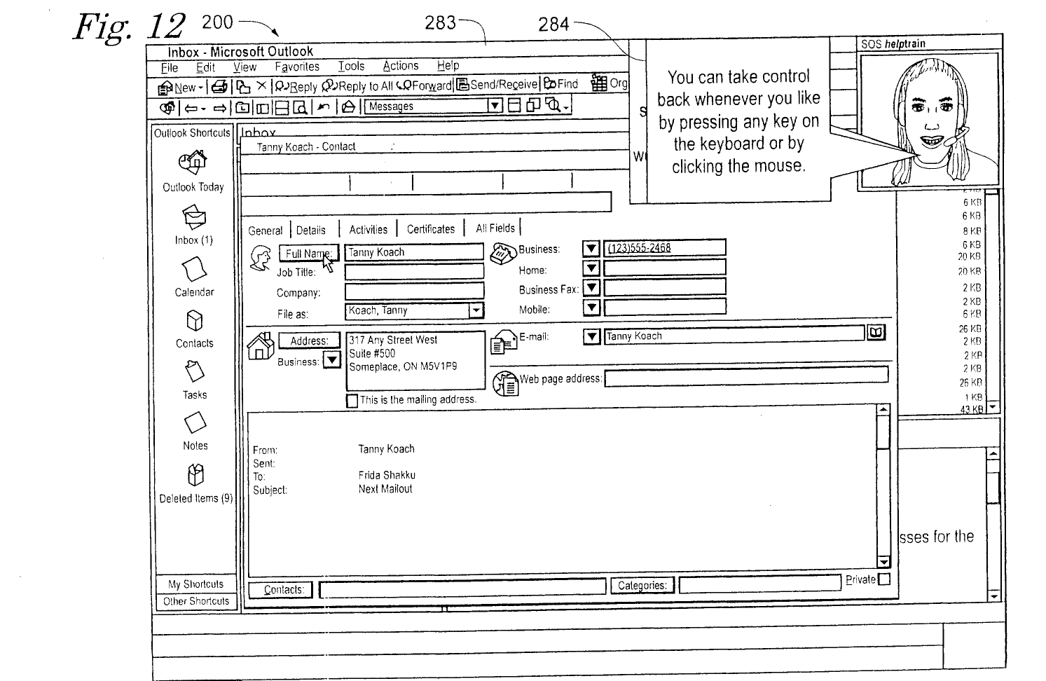

FIG. 12 illustrates a situation where the remote helper invites the requester to allow the remote helper to operate screen entry remotely. In this example, the remote helper is offering to take control of the requester's keyboard and/or mouse at 283 to demonstrate to the requester how to do something on their own display. The remote helper reminds the requester that the requester may regain control at any time, as indicated in message 284 which overlayed message 283.

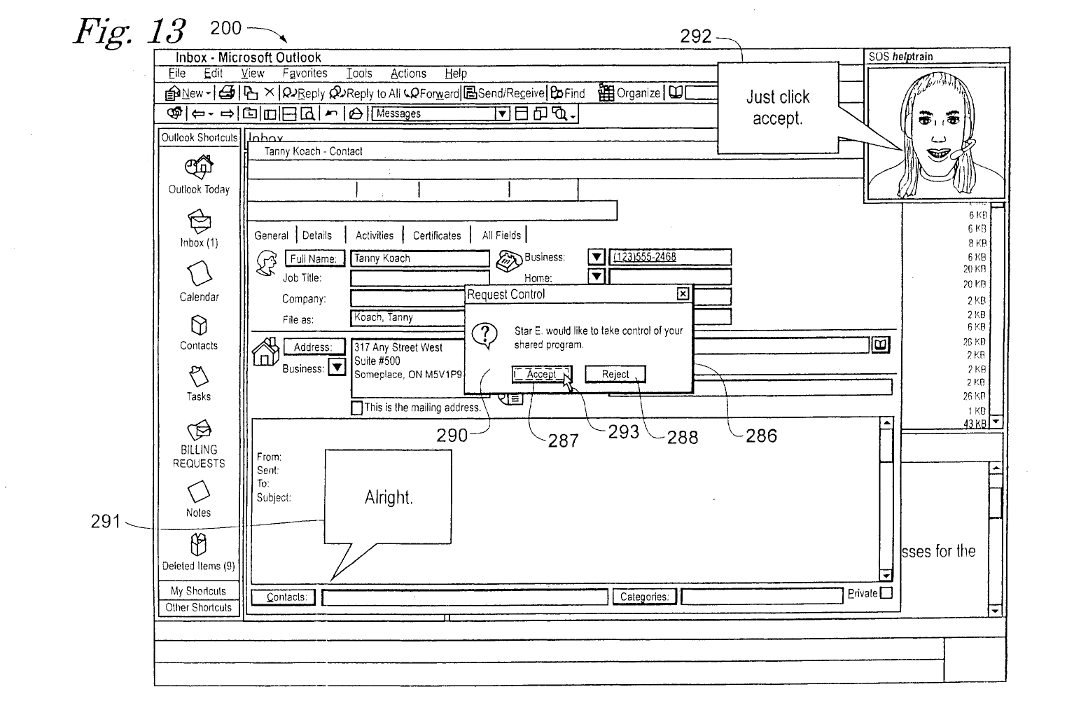

In FIG. 13, remote control or remote screen entry 286, is shown, having an accept object 287 and a reject object 288. The purpose of the object is explained in text at 290 and includes audio prompting from the helper as indicated at 292. The requester has orally accepted at 291 and has selected the accept object as indicated at 293.

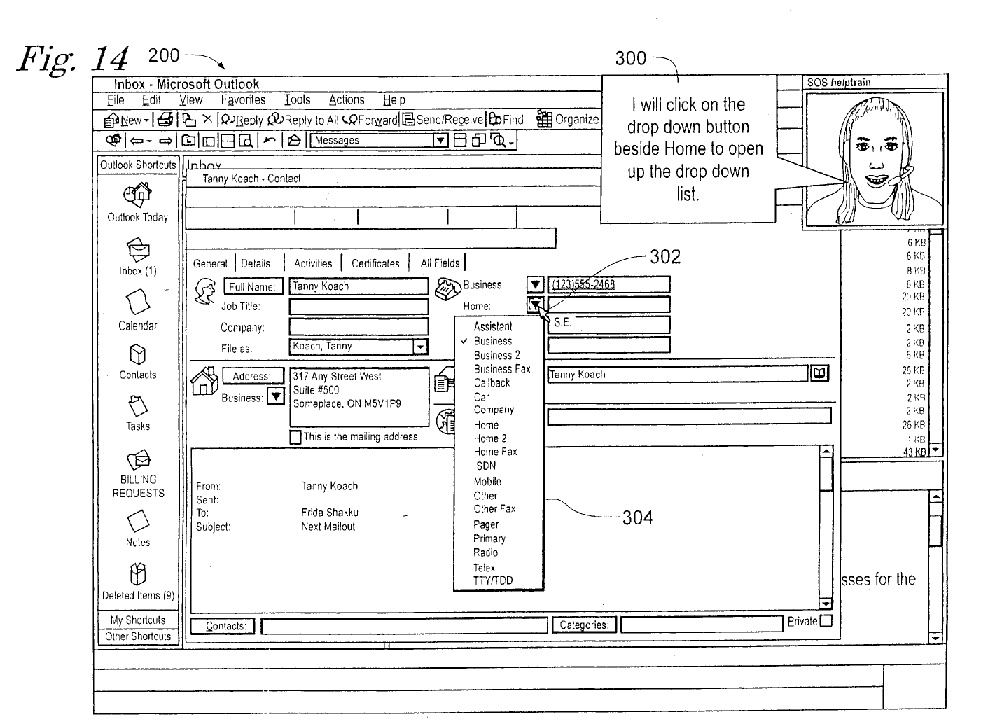

FIG. 14 illustrates the remote helper orally communicating with the requester at 300 and manipulating the curser and keyboard as indicated at 302, causing a drop down menu to appear at 304. In this way, the remote helper can actually demonstrate to the requester how to select digital device display objects and enter data at appropriate locations using the keyboard.

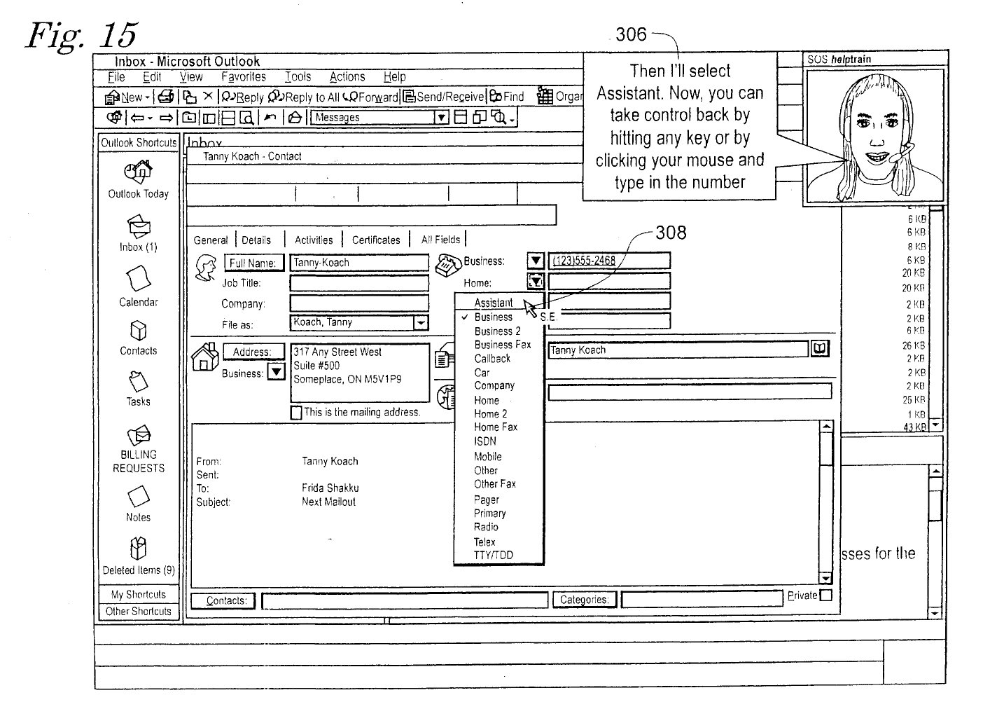

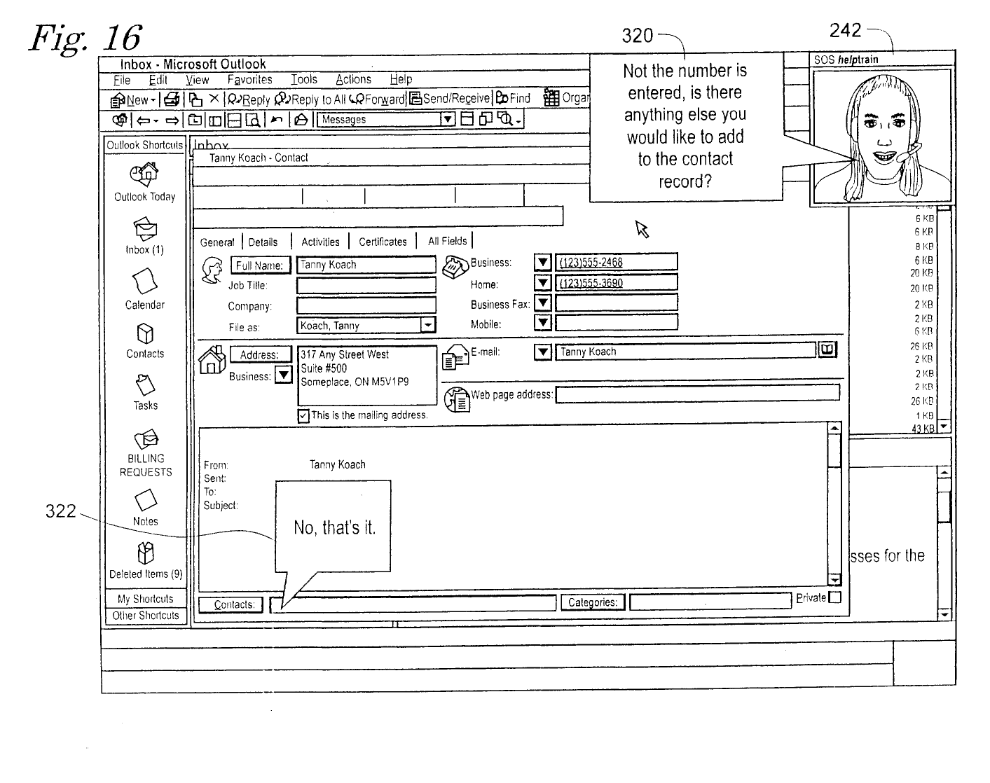

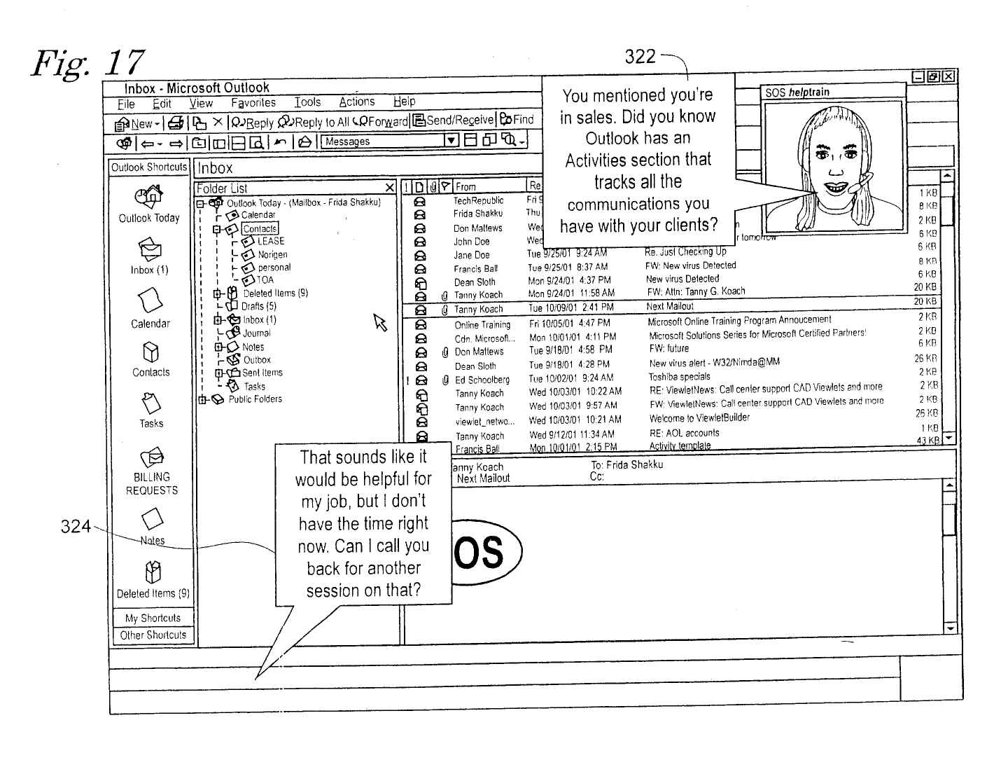

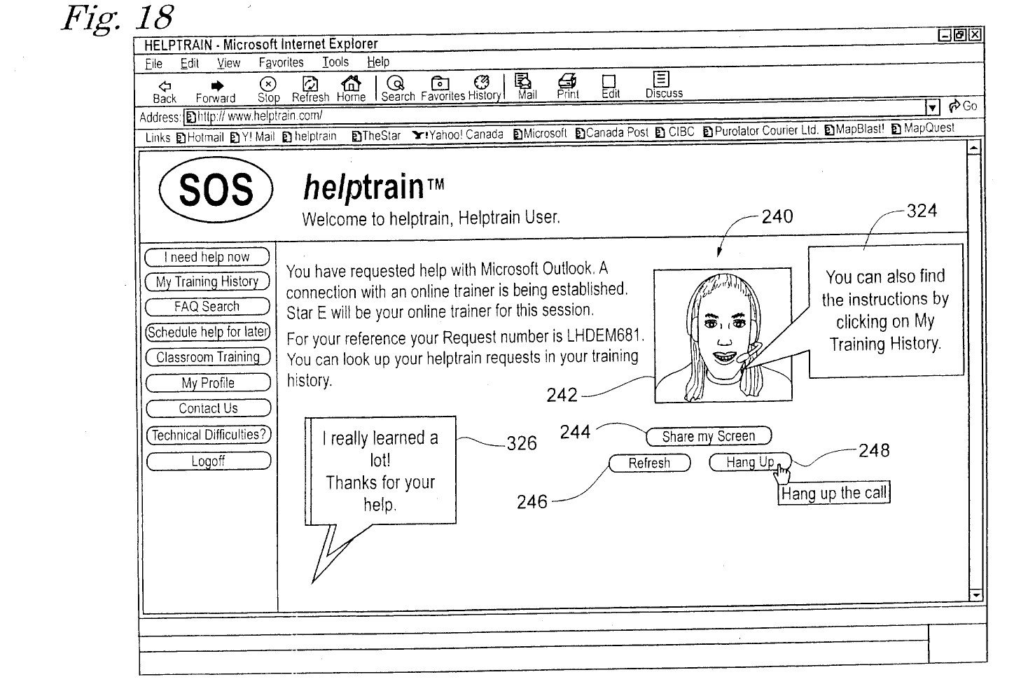

This help session continues in FIGS. 15 and 16, with the remote helper selecting a field from the drop down box at 308 and offering to relinquish control at 306. In the wind up phase of the session, the remote helper can prompt the requester to determine if any further help is needed at 320. With the requester satisfied at 322, the remote helper may offer further, related information or current or future use at 323 in FIG. 17. With the requester declining at 324, the final portion of a session is indicated in FIG. 18 with the remote helper informing the requester that the instructions covered during the session may be found in the requester's training history, at 325 or be sent to them by email. The requester may orally terminate the session at 326 and disconnect the session by selecting on connect or hang up object 248.

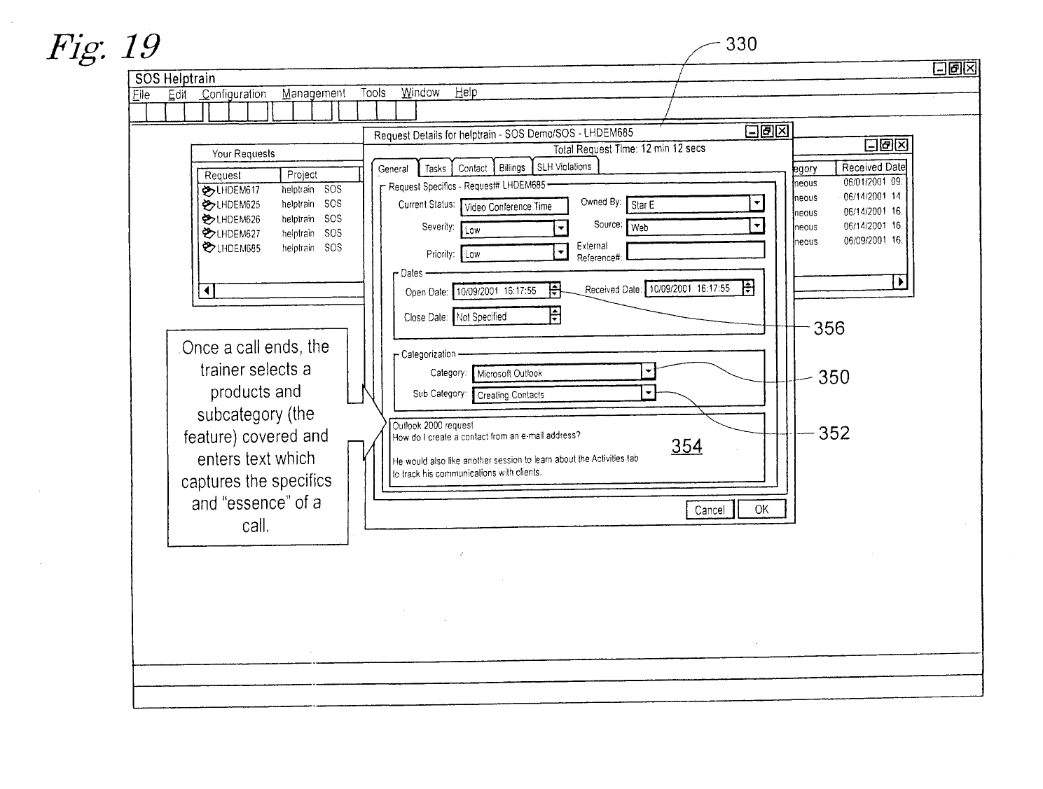

FIGS. 19 through 22 illustrate one example of how a digital device display available to the remote helper may be seen by the remote helper; for example in a supervised educational institution setting call center software may be adapted for use or used as is for this functionality. Some embodiments of the invention create displays seen by the helper using call center software. One example of suitable call center software is “Incident Monitor”, available from Monitor 24/7, Inc. (Toronto Canada). Call center management software is commonly available from multiple vendors. The call center software can be used together with video conferencing software to provide the helper with tools to assist the help requester. One suitable video conferencing package is Net Meeting, available from Microsoft Corporation (Redmond Washington).

In FIG. 19, a detail screen 330 is illustrated, having an open date 356, a subject matter category field, 350, a subject matter subcategory field 352, and a free format note entry field 354. Using screen 330, the helper may summarize the contents and result of the help session. The questions and answers covered may be entered in as much detail as appropriate.

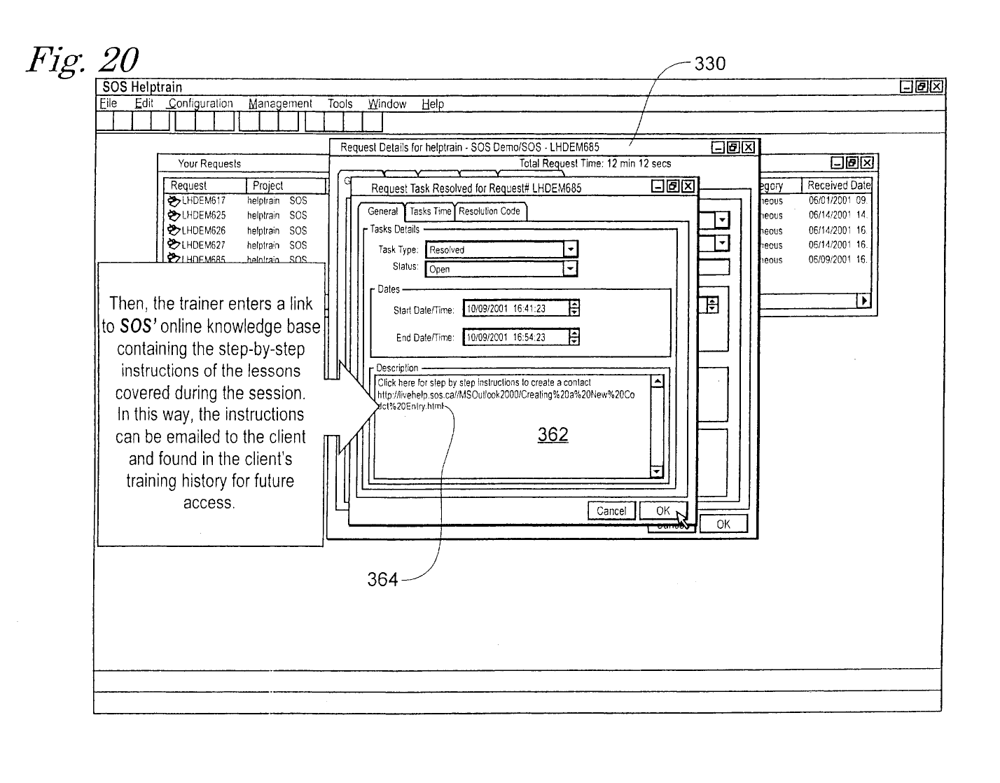

FIG. 20 illustrates yet another screen 362 which may be used to enter a link in a preexisting knowledge base related to the subject matter and subject matter subcategory covered during the session. In one example, a manual page may be copied or linked to which covers the subject matter of the question. The remote requester may later pull up their record and click on the link or help page provided, in the event they have further problems.

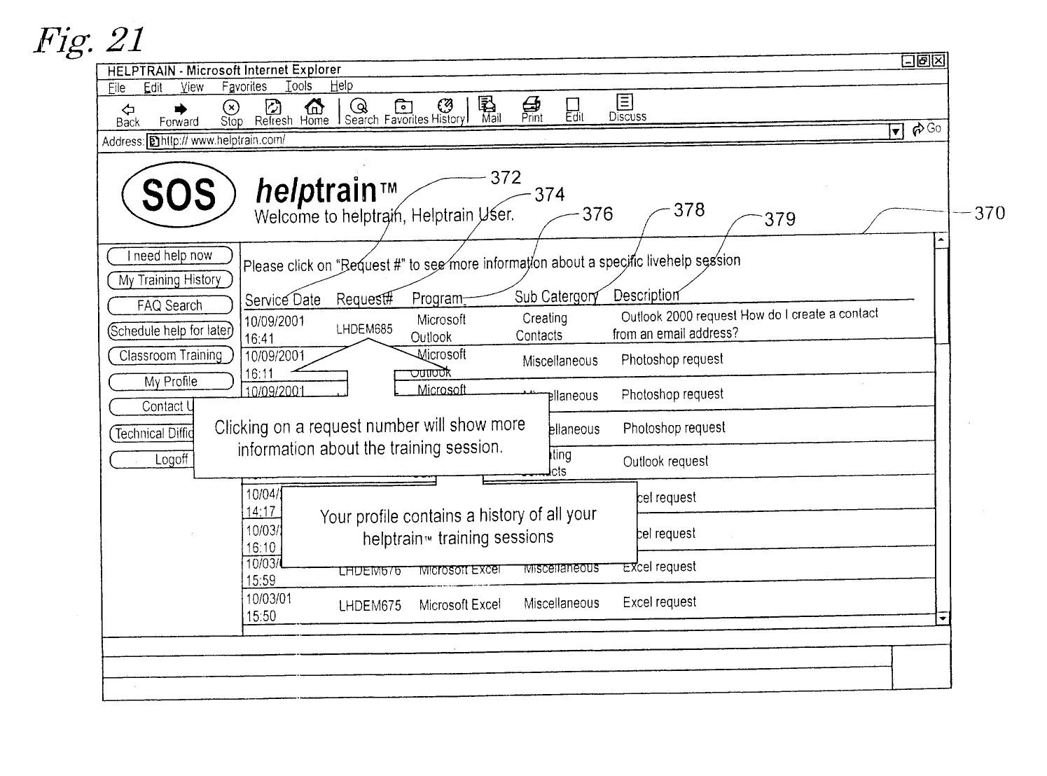

FIG. 21 illustrates one example of a database which may track the help sessions as seen by the helper. Help session database screen 370 may be seen to include a service date 372, and request or tracking number 374, a subject matter column 376, a subject matter subcategory 378, and a brief description 379.

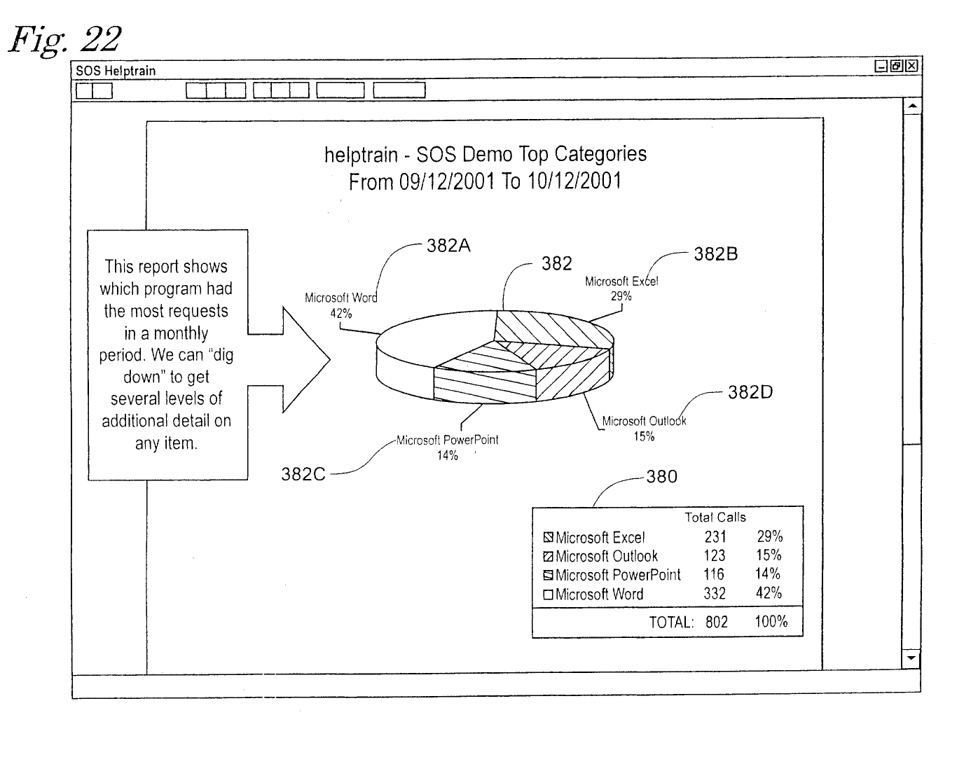

FIG. 22 illustrates yet another aspect of the present invention. Displays similar to FIG. 22 may be available to the remote helpers in some embodiments but not in other embodiments. In particular, data may be mined from the cumulative help sessions provided by the helpers and stored in a database. In the example provided, the relative proportions of questions are displayed by subject matter category in pie chart 382, including the portion spent on word processing questions at 382A, spreadsheet questions at 382B, presentation questions at 382C, and database questions at 382D. The cumulative results may also be displayed in a tabular format, as indicated in Table 380. The software product example of FIG. 22 is used for illustrative purposes only. The results may also be entered into standard report writers such as Crystal Reports. The data mined could be personal health concern subject matters, automotive service question subject matters and subcategories, and any product or service generally.

In commercial situations, where the questions are a prelude to purchase, charts such as 382 of FIG. 22 may indicate the relative portions and absolute numbers of people browsing or expressing interest in products. In one embodiment of the invention, the data mined from the cumulative help sessions is sold to interested parties in exchange for that information. The parties may have little idea that there is potential commercial interest in a particular product currently resulting in few sales. A party may also have little idea that a very small subcategory of software product is causing an inordinate number of help requests due to the product design and/or the help manual content.

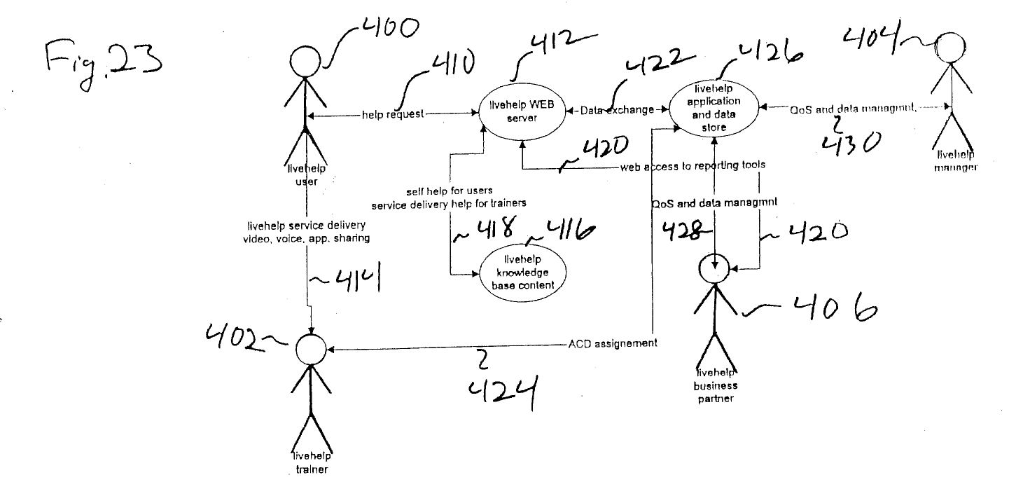

FIG. 23 illustrates a model of the present invention. A help requester or end user 400, student helper 402, a help facilitator business partner 406, and a help facilitator manager or supervisor 404 may be seen to represent the principle roles of people participating in the model of FIG. 23. Help requester 400 may be seen to communicate with the student helper 402 via communications link 414. As previously discussed, communications link 414 may be any combination of video, voice, text, and application sharing and viewing. Help requester 400 may be seen to initiate a help request 410 to the help facilitator web server 412. In some embodiments, the help facilitator web server 412 may initiate a request via communication link 418 to a help facilitator knowledge base 416. Knowledge base 416 may be used to facilitate self-help for help requesters 400. Help facilitator web server 412 may be seen to use a data exchange communication link 422 to exchange data with a help facilitator application and data store node 426.

Application and data store node 426 may be used to intelligently route the help request to the proper helper based on the attributes of the help request and the attributes of the currently available helpers in the data store. Application and data store 426 may then intelligently route the help request via communication link 424 to the selected helper 402. As is discussed elsewhere, the selection of the proper helper 402 may be based on the attributes of the helper and on other operating system type selection rules to insure speedy service, load leveling over otherwise equally qualified students, and other considerations discussed elsewhere.

A help facilitator manager or supervisor 404 may be used to monitor quality of service and maintain data through communication link 430 linked to application and data store node 426. Help facilitator manager/supervisor 404 is preferably present in a supervised setting, for example, a classroom in the educational institution. Help facilitator supervisor 404 preferably instructs the helpers 402 for a time period prior to helpers 402 being allowed to be selected to handle help requests from help requesters 400. Help facilitator supervisor 404 preferably has the ability and tools to monitor the communication link 414 in real time between help requester 400 and helper 402.

In some embodiments of the model, help facilitator business partner 406 is able to access selected quality of service and data management aspects of the data store via communication link 428. Business partner 406 may also be able to use communication link 420 to access reporting tools web server 412. One example of a business partner is a product provider wishing to mine the data available from the help request and training sessions in order to determine help requester areas of greatest concern or confusion. Another example of a business partner is a marketing executive wishing to query web server 412 to determine the product niches of greatest interest by browsing help requesters 400.

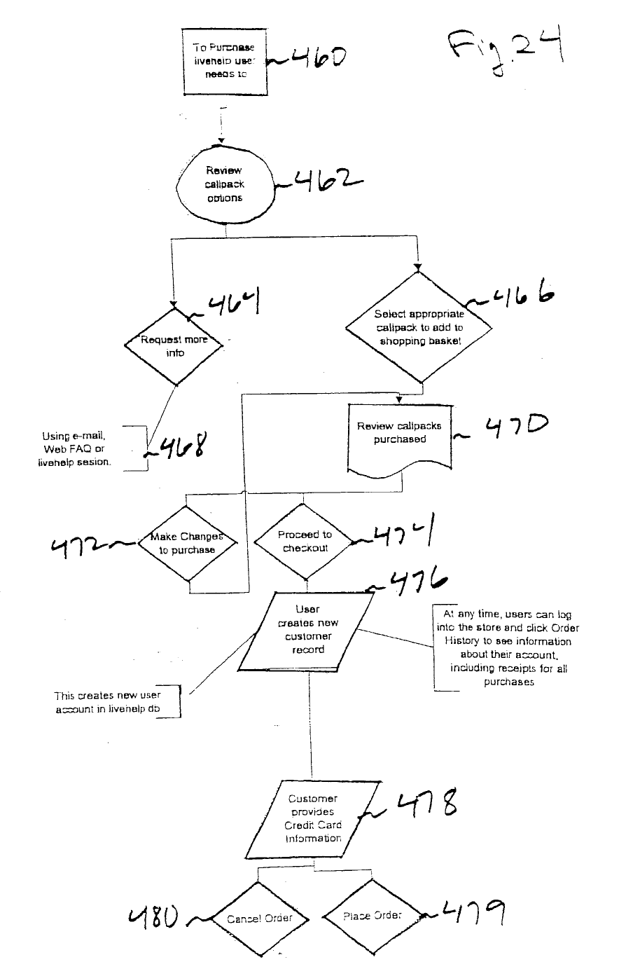

FIG. 24 is a flow chart showing how a retail user may purchase help according to one aspect of the present invention. In the step 460, the end user begins the purchasing process, proceeding to step 462 where groups of help requests may be packaged for purchase in various quantities and plans. If the purchaser proceeds to step 464, more information may be requested via email, web frequently asked questions, or through a help session established through the facilitator organization.

If the purchases proceeds to step 466, the purchaser may select appropriate packages of help or call packs and add this to the shopping basket. Proceeding to step 470, the tentatively purchased call packs may be reviewed. The tentative purchase may be changed at step 472 if desired. Proceeding to check out at step 474, the purchaser or end user can create a new customer record at 476 or change the customer record. In step 478, the end user can provide payment information, for example, credit card information or electronic cash information. Proceeding further, the end user may either cancel the order as step 480 or place the order at 479.

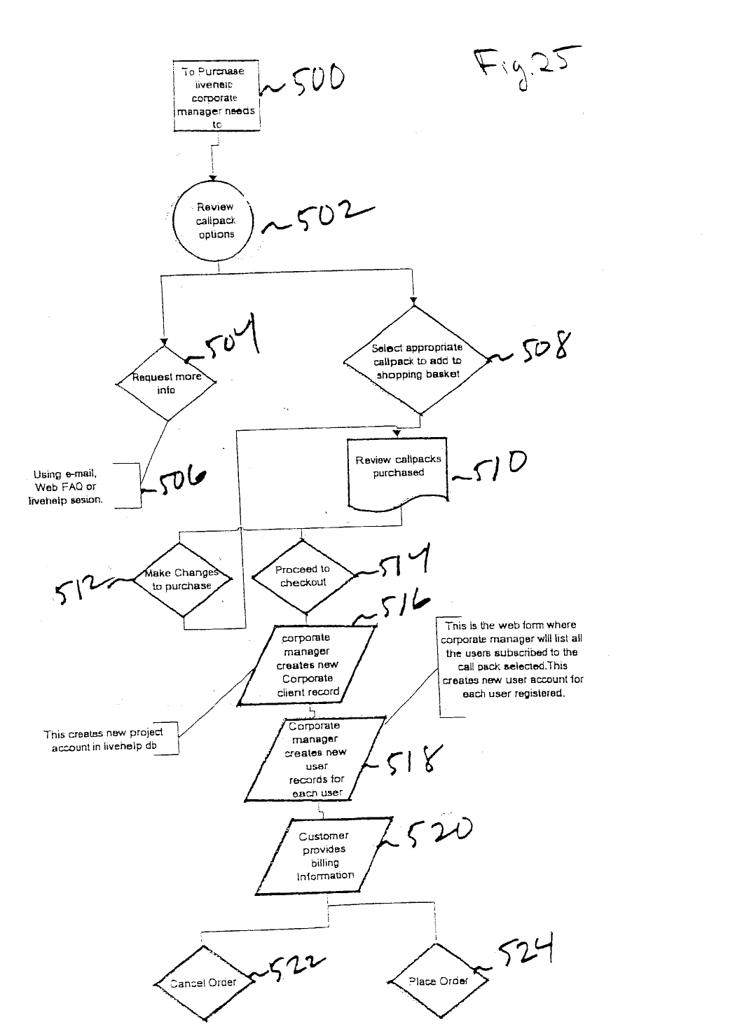

FIG. 25 is another flowchart, illustrating one way for a user aggregate or user organization to purchase help through the facilitator organization. Beginning at step 500, a user organization manager can review the offered call pack options 502, giving pricing plans for various combinations of help provided. Proceeding to step 504, more information may be requested and provided using email, web-based frequently asked questions, or an interactive help session through the facilitator organization at 506. If no more information is requested, the user organization manager may proceed to step 508 and select an appropriate call pack option to purchase the appropriate amount of help at 508. In step 510, the tentative purchases may be reviewed, and changes made at step 512, before proceeding to check out 514.

In step 516, the user organization manager may create a new user organization client record. This client record may set limits on the amount of purchases possible for the organization as a whole. One example of such a client record could be a purchase agreement for a corporation for the employees of the corporation to purchase help through the facilitator organization. Proceeding to step 518, the user organization manager can create individual records for each end user allowed to purchase help through the user organization. As previously discussed, one example of this would be a user record established for each employee, limited and authorizing possible amounts of purchase and areas of suitable help which would be provided to that employee.

In step 520, billing information may be provided prior to either canceling the order at 522 or placing the order at 524. Where the user organization is more ad hoc than a corporation and its employees, the user organization manager may be guaranteeing to pay for limited help sessions for certain classes of help requesters and/or help subject matters, with the actual requesters being as yet unknown. The user organization manager may be either agreeing to pay for the help purchased, or agree to be a guarantor of that help purchased in the event the end user does not pay for the help purchased. The user organization is typically the entity to which the bill is sent by the facilitator organization and may often be the payor of monies to the facilitator organization.

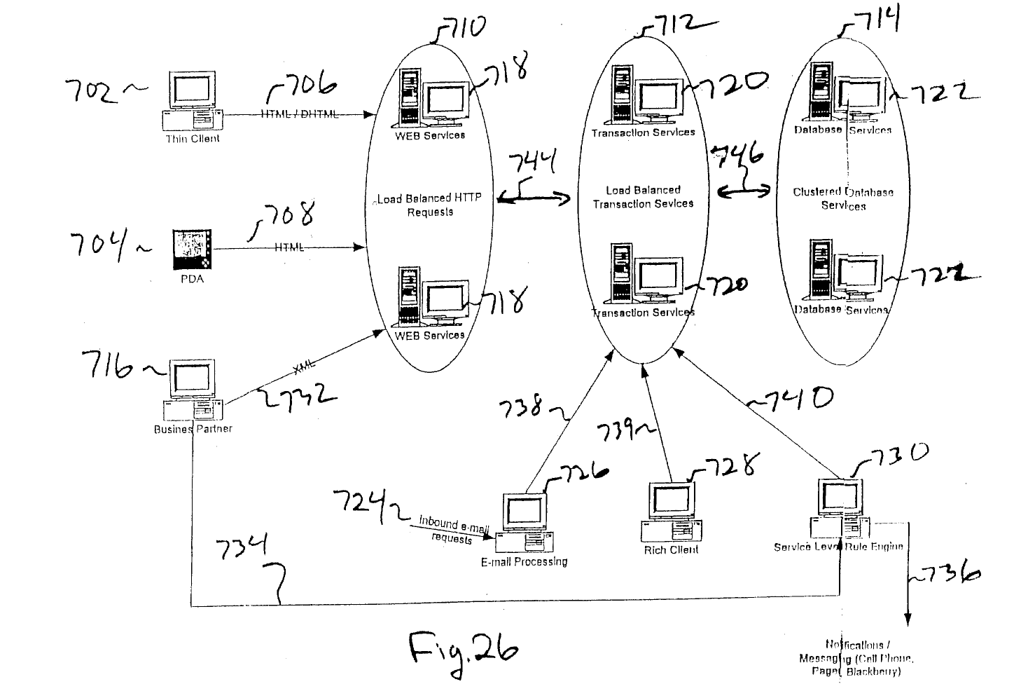

FIG. 26 illustrates a high level architecture diagram of one embodiment of the present invention. Clients in the architecture diagram can be represented by thin clients 702, for example, web browsers connected via HTML or DHTML links 706 or personal digital assistants (PDAs) 704 connected via any suitable communication link, for example, HTML link 708. A presentation layer or front end layer 710 may be seen to be coupled through communication link 744 to a middleware or transaction layer 712 which is in turn coupled through communication link 746 to a back end or a data store layer 714.

Presentation layer 710 may be seen to include a plurality of web services nodes or servers 718 which can be load balanced using techniques well known to those skilled in the art. Similarly, middleware layer 712 may be seen to have a plurality of transaction processors 720 which may also be load balanced using well known techniques. Data store layer 714 may be seen to have a plurality of data base service nodes 722 which may be clustered using well known techniques.

A business partner node 716 may be seen to be coupled through data communication line 732 to presentation layer 710. Business partner 716 may be making queries as to the nature and relative amounts of various queries through the reporting function, as previously discussed. Business partner 716 may also be coupled through a link 734 to a service level rule engine node 730. An email processing node 726 may be seen to accept inbound email requests 724, passing those requests through communication link 738 to middleware layer 712. In this way, requests for help via email may be processed in some embodiments of the invention.

A rich client node 728 may also be coupled through data communication link 739 to middleware layer 712. In one embodiment, rich client 728 is a Visual Basic Application running on a digital device. Rich client 728 may be used to view help requester information, view user organization information, log in students, register IP addresses of students, open help requests, work on the help requests, and close the help requests. Service level rule engine node 730 may send modifications to the service level rules via communication link 740 to middleware layer 712. Service level rule engine node 730 may also be used to monitor the queue loads for quality of service issues and generate reports for managers for the facilitator organization. Service level rule engine 730 may also be used to notify employees of the facilitator organization via communication link 736 which can include messages via cell phones, pagers, blackberry type units, and via the Internet. Such notification is useful for alerting managers of quality of service issues, for example, system nodes being down and/or cues being excessively long.

### Example of One Way to Create a Help Communication Object for Audio/Voice/Screen Share and Remote Control

Applicants believe that the foregoing document would enable one skilled in the software arts to create digital device objects which could reside on a digital device display, and allow a remote student helper to communicate help and information through audio, video, screen sharing, and remote control of data entry onto the user's digital device display. Preferring to err on the side of too much disclosure, applicants have included text below describing how to create such an object by modifying readily available off the shelf software components, which, in this example, is NetMeeting, available from Microsoft Corporation (Redmond Wash.).

This text describes the Net Meeting Integration interface to manipulate Net Meeting within any environment that supports COM controls (including VB, VC++, VJ, VBScript, JavaScript). This component extends the current supported functionality supplied by Net Meeting to provide a collection of shared applications and a single click approach to application sharing. Several C++ classes COM objects have been created to add this functionality to Net Meeting.

Overview

A Net Meeting installation provides a stock COM control which provides basic functionality for embedding into web pages and other COM control containers. This shipping component provides the ability to start and stop a conference and determine whether or not Net Meeting is in a conference. One way to extend this functionality is to develop a custom COM control within the C++ environment that has access to the Interface Definition Language (IDL) file that ships with Net Meeting. This allows the developer to “hook” onto any Net Meeting channel and gain control over the channel. Net Meeting channels are as follows:

Net Meeting Manager ( )

Conference Manager

Video

Audio

Application Sharing

Data

Chat

White Board.

The remainder of this document will describe the C++ object and the COM component model supplemented with code examples. The Application Sharing channel is currently supported. The framework is in place to allow the developer to easily extend this component model to support other channels.

Component Assembly

In order to provide access to Net Meeting channels that are not exposed through the base product, several C++ classes have been created which in turn are assembled to develop a component model that can be used in any language that supports COM. The Object Model detailed below is the C++ class object model which when assembled completes the Component Model which is accessible through any COM supported development language (i.e. allowing you to leverage all major development and scripting environments).

Overview

Net Meeting uses, extensively, COM connection points to provide a call back mechanism for channel notifications to applications that have “subscribed” to one or more of the Net Meeting channels. The C++ object model provides the framework to easily develop and extend the supported channels for these connection point notifications. The objects were created manually (as opposed to ATL generated) as the ATL environment does not support the implementation of connection points unless a type library exists. Therefore, it was more expeditious to develop a simple C++ object model to support this (as derived from the nmshare sample provided in the Net Meeting Resource Kit).

C++ Object Model

The text below describes the object model to derive ANY channel specific sink.

The object hierarchy above shows that a channel notification object is derived by inheriting from the three abstract base classes of:

RefCount. This provides the standard COM AddRef, Release, and QueryInterface methods that are required for a Component to be COM compliant.

CNotify. This provides the abstract base class to connect and disconnect from a connection point (i.e. Net Meeting connection point).

Channel Specific Interface. This provides the Net Meeting Channel Specific Interface that Net Meeting will use to call back the component on (i.e. this is the subscriber interface for the Net Meeting specific channel). The following channels have been implemented:

Net Meeting Manager—provides the call back to be notified when the conference is started. This is used to obtain a reference to the Net Meeting to the Net Meeting conference object that is passed in.

Net Meeting Conference Manager—provides the call back interface to receive notifications on the state of the conference and its associated channels. This presently supports the Application Sharing channel.

RefCount CNotify Channel Specific

Interface

Channel Notifier

Application Sharing Channel—provides the call back interface to receive notifications on the change of state of a the application sharing state within the conference.

Any new channels need only to follow the Application Sharing Channel as an example as the Net Meeting Manager and Net Meeting Conference Manager are Net Meeting framework channels that hook the conference and the conference channels and only one instance of each is required in this specific implementation.

Component Model

The component model assembles the C++ classes together to derive a scriptable component based interface to the Net Meeting channel outline above. This facilitates the embedding of the components into a web page and providing access to Net Meeting resources that would otherwise be unavailable in scripting environments.

The component model is displayed below. It consists of four main components (all other components are support components not exposed externally):

1. ConferenceManager

2. AppSharing

3. SharableApplications

4. SharableApplication

The ConferenceManager provides the main interface to connect and establish “hooks” to the supported channels. The AppSharing object exposes all of the functionality required to manage the Application Sharing channel. The SharableApplications object exposes a collection of SharableApplications on the machine and the SharableApplication contains the specifics of an individual SharableApplication and enumerated by the Net Meeting environment.

1. Details on methods and properties of these components can be viewed through the object browser of any development environment—these items are fully documented in freely available books.

IUnknown

ConferenceManager IUnknown

App Sharing Notify

IUnknown

Conference Notify

IUnknown

Manager Notify

IUnknown

Nm Manager

IUnknown

AppSharing

INmManagerNotify

INmConferenceNotify

INmChannelAppShareNotify

areNotify

INmManager

IUnknown

AppSharing

IUnknown

Channel App Sharing

IUnknown

Sharable Applications (collection of SharableApplication objects)

INmChannelAppShare

ConferenceManager

When a ConferenceManager component is instantiated it initializes itself. It is not until the Initialize method is called that it attempts to connect to a Net Meeting conference. If this is successful an instance of the every component shown in the diagram below will exist.

Manager Notify. Provides the call notification object to hook to the Net Meeting manager.

Conference Notify. Provides the call notification object to hook to the Net Meeting Conference manager.

App Sharing Notify. Provides the call notification object to hook to the Net Meeting Application Sharing channel.

As you can deduce the ConferenceManager uses COM containment to encapsulate this functionality into a single, easy-to-use COM component. New channels added would follow this same containment model using the AppSharing object as a template.

Nm Manager. This contains a reference to the Net Meeting Manager. This differs from the notification object as the notification object is used for call backs issued to the ConferenceManager from the Net Meeting environment. This reference provides access to the base Net Meeting manager as created by this Initialize method.

AppSharing. This object is exposed as a property on the ConferenceManager object. This object contains all knowledge of the Application Sharing channel and exposes a collection of SharableApplications.

AppSharing

This component manages the specifics of the Application Sharing channel within the Net Meeting environment. It exposes a Collaborate and StopCollaborating for control over the channel coupled with a collection of SharableApplications to offer full control of Application sharing within the Net Meeting environment through a scriptable interface.

SharableApplications

This object provides standard collection semantics to allow any scripting environment or language access to the collection of sharable applications on the machine. This collection is Read-Only and must be refreshed by calling the RefreshSharableApplicationCollection on the AppSharing component.

SharableApplication

This component encapsulates all the properties required to properly manage a Net Meeting sharable application. The ShareMe method will initiate sharing of the application and bring the application to the forefront for a single user click experience for application sharing (this compares to the 3 or 4 that a user would have to do coupled with moving the application to the foreground).

Code Samples

The following is a code sample provided in VBScript to demonstrate the capabilities of this component model.

Chapter 2: Component Assembly

Sample Code

<script LANGUAGE=“VBScript”>
dim oNMConf ′reference to ConferenceManager
dim oApps ′reference to SharableApplications collection
dim oAppShare ′reference to AppShare component
dim lTimerId
′create an instance to make maintenance and is nothing checks easier.
set oNMConf = Create Object(“Monitor247NM.ConferenceManager”)
Sub ReLoad
′check to see if a conference has been started
if NetMeeting.IsInConference() then
′if the conference is started and we are being disconnected and have successfully
′hooked the conference then Unitialize.
if not oNMConf is nothing then
oNMConf.UnInitialize
set oNMConf = nothing
end if
NetMeeting.LeaveConference
end if
′submit the form to reload the page
frmReLoad.submit
end sub
Sub ShowDetails
′check to see if a conference has been started
if NetMeeting.IsInConference() then
′tear down the conference because we are leaving
if not oNMConf is nothing then
oNMConf.UnInitialize
set oNMConf = nothing
end if
NetMeeting.LeaveConference
end if
′show request details
frmDetails.submit
end sub
sub CallResource(strLocator, strName)
′End any previous calls
EndCall
spnConnect.innerHTML = “Connecting to” & strName
′place the call to specified locator (IP address)
PlaceCall strLocator
end sub
′Net Meeting events from embedded control
sub NetMeeting_ConferenceStarted()
′set a timer to toggle the SOS LiveHelp display
lTimerId = window.setTimeout(“InConference”, 1000, “VBScript”)
spnConnect.style.visibility= “hidden”
end sub
sub NetMeeting_ConferenceEnded()
ShowLiveHelp
if not oNMConf is nothing then
oNMConf.UnInitialize
set oNMConf = nothing
end if
end sub
sub EndCall
ShowliveHelp
if NetMeeting.IsInConference() then
if not oNMConf is nothing and not isempty(oNMConf) then
oNMConf.UnInitialize
set oNMConf = nothing
end if
NetMeeting.LeaveConference
end if
end sub
. . .
Sample Code
sub InConference
window.clearTimeout lTimerId
ShowNetMeeting
set oNMConf = Create Object(“Monitor247NM.ConferenceManager”)
oNMConf.Initialize
DisplayApplications
end sub
′enumerates the applications and prepares them for display by initializing the global
′variable oAppShare
sub DisplayApplications
dim oApp
set oAppShare = oNMConf.ApplicationSharing
if oAppShare is nothing then
msgbox “The Net Meeting video channel has not been initialized. Please ensure that
you have Net Meeting installed.”
exit sub
end if
set oApps = oAppShare.SharableApplications
if oApps is nothing then
msgbox “There are no available applications to share. Please execute the
<%=Response. Write(oRequest.mCategory)%> application before continuing.”
exit sub
end if
end sub
. . .
Sample Code
sub ShowMe
if not oAppShare is nothing then
oAppShare.Collaborate
oAppShare.RefreshSharableAppCollection
oAppShare.StopCollaborating
set oApps = oAppShare.SharableApplications
if not isempty(oApps) then
for each oApp in oApps
if Instr(1,oApp.Name, “<%=oRequest.mCategory%>”) > 0 then
ShowApp oApp
exit sub
end if
next
msgbox “You must start the <%=Response.Write(oRequest.mCategory)%> application
before proceeding. Start the application and click refresh to continue.”
exit sub
end if
end if
msgbox “You must successfully establish a LIVEHELP call before you can be walked
through your problem.”
end sub
sub ShowApp(oApp)
If oApp.IsShared() Then
oApp.UnShare
oAppShare.StopCollaborating
Else
oApp.ShareMe
oAppShare.Collaborate
End If
End Sub
. . .
Sample Code
sub ShowNetMeeting
LiveHelp.style.visibility= “hidden”
NetMeeting.style.visibility = “visible”
end sub
sub ShowLiveHelp
LiveHelp.style.visibility= “visible”
NetMeeting.style.visibility = “hidden”
end sub
′window events
sub window_onLoad()
Place Call “<%=oAssgnResource.mIPAddress%>”
end sub
sub window_onbeforeunload()
if NetMeeting.IsInConference() then
NetMeeting.style.visibility.= “hidden”
NetMeeting.LeaveConference
end if
end sub
</script>
Sample Code

What is claimed is:

1. A method for providing information over a communications network, the method comprising the steps of:
(a) receiving a help request in a subject area from a networked digital device user over the network, wherein the digital device is selected from the group consisting of personal computers, hand held computers, personal digital assistants, hard wired computer terminals, wireless computer terminals, cellular telephones, hard wired telephones, wireless telephones, embedded devices, interactive TV and combinations thereof,
(b) selecting a student to provide help to the user, wherein the student has knowledge in the subject area, the student is available to provide the help in the subject area, and the student is in a supervised class setting in an educational institution at the time of the help request; and
(c) establishing a communication link between the user and the student over the network to allow the selected student to provide help to the user over the network while in the supervised class setting.

2. A method as in claim 1, wherein the receiving help request step is received over the Internet.

3. A method as in claim 1, wherein the selecting step includes selecting based on a level of student knowledge in the subject matter.

4. A method as in claim 1, further comprising maintaining a history of the amount of help provided by the students, wherein the selecting step includes selecting at least in part based on the amount of help the students have provided based on the history.

5. A method as in claim 1, further comprising obtaining a subject matter mastery level for the user and obtaining a subject matter mastery level for the students, wherein the selecting step includes selecting at least in part based on matching the subject matter mastery levels of the student to the user.

6. A method as in claim 5, wherein the obtaining user subject matter mastery level step includes obtaining explicitly provided subject matter mastery level information supplied by a source selected from the group consisting of the user and the student.

7. A method as in claim 5, wherein the obtaining user subject matter mastery level for the user includes estimating the mastery level based on a history of previous help requests from the user.

8. A method as in claim 5, wherein the obtaining student subject matter mastery level includes at least in part estimating the subject matter mastery level from a history of previous help provided.

9. A method as in claim 1, wherein the establishing communication link step includes obtaining a network address for the student and passing the student network address to the user to enable the user to establish a network connection to the student.

10. A method as in claim 1, wherein the establishing communication link step includes obtaining a network address for the user and passing the user network address to the student to enable the student to establish a network connection to the user.

11. A method as in claim 1, wherein the receiving help request step results from the user manipulating a help object on the computer user display.

12. A method as in claim 11, wherein the network includes the Internet, wherein the establishing communication link step includes obtaining an Internet protocol address for the selected student and passing the selected student Internet protocol address to the user to enable the user to establish an Internet connection to the selected student.

13. A method as in claim 12, wherein the user establishes a communication link including receiving video and/or voice from the student.

14. A method for providing support experience for a plurality of students in a supervised setting in an educational institution, wherein the students are reachable or addressable through communication while in the supervised setting, the method comprising the steps of:
(a) receiving a support request from a remote requester in a subject area, wherein the requester is remote from the student;
(b) selecting a student to provide assistance to the requester while the student is in the supervised setting; and
(c) establishing a communication link between the requester and the student to allow two-way communication between the requester and the student while the student is in the supervised setting.

15. A method as in claim 14, wherein the establishing communication link step includes establishing an audio communication link between the student and the requester.

16. A method as in claim 15, wherein the establishing communication link step includes establishing a video communication link from the student to the user.

17. A method as in claim 16, wherein the establishing communication link step includes establishing an audio and video communication from the student to the user.

18. A method as in claim 14, further comprising providing digital device and communication hardware to the educational institution, wherein the digital device is selected from the group consisting of personal computers, hand held computers, personal digital assistants, hard wired computer terminals, wireless computer terminals, cellular telephones, hard wired telephones, wireless telephones, embedded devices, interactive TV and combinations thereof, wherein the digital device hardware and communication hardware are coupled to the communication link and are used by the students to provide help to the user.

19. A method as in claim 14, wherein the selecting student step is based at least in part on selection criteria selected from the group consisting of subject matter mastery level matching between the student and the user, the immediate availability of the student, the time zone matching of the student and the user, previous dealings between the student and the user, and the amount of help provided by the student, and combinations thereof.

20. A method as in claim 14, further comprising pre-screening the students before they are allowed to participate in the supervised setting.

21. A method as in claim 14, wherein the receiving support request is received over the Internet, wherein the selecting student step is performed over the Internet, wherein the establishing communication link includes establishing an Internet connection between the requester and the student.

22. A method for providing support to a computer user from a computer display, wherein the computer is connectable to a computer network, the method comprising the steps of:
(a) providing a help request object displayable and selectable from the computer display;
(b) upon selection of the help request object, sending a help request over the network requesting real time human assistance, wherein the help request comprises a requester identifier, and apayor identifier or an authorization ID;
(c) receiving a helper network ID;
(d) establishing a communication link to the human helper over the network using the helper network ID;
(e) sending a specific help request to the helper over the network; and
(f) receiving help information from the human helper in response to the sent specific help request.

23. A method as in claim 22, further comprising providing a help video display object for displaying a video image of the human helper on the computer display.

24. A method as in claim 23, wherein the video display object is periodically updated with more recent video images of the human helper.

25. A method as in claim 22, further comprising providing a help audio object for sending an audio stream from the human helper through the computer.

26. A method as in claim 22, further comprising providing a help video display object for displaying a video image of the human helper on the computer display and providing an audio object for transmitting an audio signal from the human helper to the requester over the network.

27. A method as in claim 22, further comprising providing a selectable screen-sharing object, which, upon selection, sends at least one image of the user screen to the human helper over the network.

28. A method as in claim 22, further comprising providing a selectable remote control enable object, which upon selection, enables the human helper to remotely move a cursor and remotely make keyboard entries onto the user computer display.

29. A method as in claim 22, wherein the help request includes help request attributes selected from the group consisting of user identifier and subject matter identifier.

30. A method as in claim 29, wherein the help request attributes further comprises user subject matter mastery level.

31. A method as in claim 29, wherein the help request attributes further include an organization the user is associated with.

32. A method for handling help requests from digital device users, the method comprising the steps of:
(a) receiving a help request from a networked digital device user; and
(b) sending the help request over a network to a student in their educational institution in a supervised classroom setting.

33. A method as in claim 32, wherein the sending help request step is performed by a help facilitator organization.

34. A method as in claim 32, further comprising obtaining a network address of the student, and sending the student network address to the network address from which the help request came, to enable the help requester and student to establish a communication link over the network.

35. A method for managing a student populated help support center at an educational institution, the method comprising the steps of:
(a) providing a data communication link to the help support center;
(b) providing a human interface device at the help support center affiliated with the educational institution, wherein the human interface device is coupled to the data communication link and allows communication between the data communication link and a human being at the human interface device;
(c) providing a supervising instructor at the help support center;
(d) providing a plurality of help requests from help requesters located remotely to the help support center;
(e) selecting a student to answer the help request over the data communication link and using the human interface device; and
(f) directing the help request to the selected student.

36. A method as in claim 35, wherein the human interface device is selected from the group consisting of computer terminals, computers, wired telephones, wireless telephones, personal digital assistance, embedded devices, interactive TV and text-based entry devices.

37. A method as in claim 35, wherein the providing plurality of help requests step, the selecting student step, and the directing help requests step are all performed by a help facilitator organization.

38. A method as in claim 35, wherein the provided supervising instructor provides instruction to the students prior to allowing students to be selected for calls.

39. A method as in claim 35, wherein the selecting students step is based at least in part on the subject matter mastery of the student and the availability of the student.

40. A method as in claim 35, wherein the provided supervising instructor is enabled to monitor communication between the students and the remote help requesters.
